(19) United States
(12) Patent Application Publication
(10) Pub. No.: US 2024/0172303 A1
(43) Pub. Date: May 23, 2024

(54) SIDELINK USER EQUIPMENT SCHEDULING OF SPATIAL DIVISION MULTIPLEXING RECEIVER WITH MULTIPLE TRANSMISSION-RECEPTION POINTS

(71) Applicant: QUALCOMM Incorporated, San Diego, CA (US)

(72) Inventors: Hui GUO, Beijing (CN); Kapil GULATI, Belle Mead, NJ (US); Shuanshuan WU, San Diego, CA (US); Junyi LI, Fairless Hills, PA (US); Sourjya DUTTA, San Diego, CA (US)

(21) Appl. No.: 18/549,138

(22) PCT Filed: Apr. 23, 2021
(86) PCT No.: PCT/CN2021/089229

§ 371 Date: Sep. 5, 2023

(51) Int. Cl. H04W 76/14; H04L 5/00; H04W 72/40; H04W 92/18

(52) U.S. Cl. CPC H04W 76/14; H04L 5/0051; H04W 72/40; H04W 92/18

(57) ABSTRACT

Methods and devices for wireless communications are described. A first user equipment (UE) may establish a first sidelink connection with a second UE and a second sidelink connection with a third CE. The first UE may receive an indication of a first set of transmission resources for the second UE to use to transmit to the first UE. The first UE may transmit an indication of a second set of transmission resources for the second UE to use to transmit to the first UE, the second set of transmission resources identified by the first UE based at least in part on comparing signals received using the first transmission reception point with signals received using the second transmission reception point. The first UE may receive a data message from the second UE on the second set of transmission resources.

### CROSS REFERENCE

The present application is a 371 national stage filing of International PCT Application No. PCT/CN2021/089229 by GUO et al. entitled “SIDELINK USER EQUIPMENT SCHEDULING OF SPATIAL DIVISION MULTIPLEXING RECEIVER WITH MULTIPLE TRANSMISSION-RECEPTION POINTS,” filed Apr. 23, 2021, which is assigned to the assignee hereof, and which is expressly incorporated by reference in its entirety herein.

### FIELD OF TECHNOLOGY

The following relates to wireless communications, including sidelink user equipment scheduling of spatial division multiplexing receiver with multiple transmission-reception points.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Additionally or alternatively, a first UE may communicate with multiple other UEs via sidelink communications on one or more. However, such sidelink communications may be relatively inefficient. For example, the UEs may experience relatively poor resource utilization, which may degrade communications efficiency, increase latency, or both.

### SUMMARY

The described techniques relate to improved methods, systems, devices, and apparatuses that support sidelink user equipment scheduling of spatial division multiplexing receiver with multiple transmission-reception points. Generally, the described techniques enable a first user equipment (UE) to schedule spatial division multiplexing (SDM) communications for other UEs in a wireless communications system, which may result in improved resource utilizations and system efficiency. For example, the first UE may be an example of a receiving UE with multiple transmission reception points (TRPs). The first UE may establish sidelink connections with other UEs, such as a first sidelink connection with a second UE, a second sidelink connection with a third UE, and so on. The first UE may use the multiple TRPs to perform measurements and enable SDM communications amongst the group of UEs.

For example, the first UE may receive sidelink control information from the second UE and the third UE on the respective sidelink connections (e.g., unicast connections). The first UE may obtain measurements associated with receiving the sidelink control information on each TRP (e.g., reference signal received power (RSRP) measurements, received signal strength indicator (RSSI) measurements, signal to noise ratio measurements, signal to interference plus noise ratio (SINR) measurements, or other measurements of signal power, signal or channel quality, beam conditions, and the like). The UE may determine that the second UE and the third UE may use a same set of time frequency resources based on the measurements satisfying one or more thresholds. Accordingly, the first UE may transmit an indication to one or more UEs scheduling multiple UEs to use a same set of resources (e.g., the second and third UEs may transmit SDM communications to the first UE on the set of resources), which may improve communications efficiency in the system while maintaining a relatively high signal quality. As an example, the first UE may indicate one or more parameters to other UEs configuring or scheduling the other UEs with the SDM communications. The one or more parameters may include or indicate a demodulation reference signal (DMRS) cyclic shift, channel measurement resources (CMR), interference measurement resources (IMR), a group index associated with the one or more parameters, an indication of the set of resources, a subchannel index, a transmission time, a DMRS port index, or any combination thereof, among other examples of parameters.

A method for wireless communications at a first UE is described. The method may include establishing a first sidelink connection with a second UE and a second sidelink connection with a third UE, the first sidelink connection using a first TRP of the first UE, and the second sidelink connection using a second TRP of the first UE, receiving, from the second UE using the first sidelink connection, an indication of a first set of transmission resources for the second UE to use to transmit to the first UE, transmitting, to the second UE at least in part in response to the first set of transmission resources, an indication of a second set of transmission resources for the second UE to use to transmit to the first UE, the second set of transmission resources identified by the first UE based on comparing signals received using the first TRP with signals received using the second TRP, and receiving, using the second set of transmission resources, a data message from the second UE via the first sidelink connection.

An apparatus for wireless communications at a first UE is described. The apparatus may include a processor, memory coupled with the processor, and instructions stored in the memory. The instructions may be executable by the processor to cause the apparatus to establish a first sidelink connection with a second UE and a second sidelink connection with a third UE, the first sidelink connection using a first TRP of the first UE, and the second sidelink connection using a second TRP of the first UE, receive, from the second UE using the first sidelink connection, an indication of a first set of transmission resources for the second UE to use to transmit to the first UE, transmit, to the second UE at least in part in response to the first set of transmission resources, an indication of a second set of transmission resources for the second UE to use to transmit to the first UE, the second set of transmission resources identified by the first UE based on comparing signals received using the first TRP with signals received using the second TRP, and receive, using the second set of transmission resources, a data message from the second UE via the first sidelink connection.

Another apparatus for wireless communications at a first UE is described. The apparatus may include means for establishing a first sidelink connection with a second UE and a second sidelink connection with a third UE, the first sidelink connection using a first TRP of the first UE, and the second sidelink connection using a second TRP of the first UE, means for receiving, from the second UE using the first sidelink connection, an indication of a first set of transmission resources for the second UE to use to transmit to the first UE, means for transmitting, to the second UE at least in part in response to the first set of transmission resources, an indication of a second set of transmission resources for the second UE to use to transmit to the first UE, the second set of transmission resources identified by the first UE based on comparing signals received using the first TRP with signals received using the second TRP, and means for receiving, using the second set of transmission resources, a data message from the second UE via the first sidelink connection.

A non-transitory computer-readable medium storing code for wireless communications at a first UE is described. The code may include instructions executable by a processor to establish a first sidelink connection with a second UE and a second sidelink connection with a third UE, the first sidelink connection using a first TRP of the first UE, and the second sidelink connection using a second TRP of the first UE, receive, from the second UE using the first sidelink connection, an indication of a first set of transmission resources for the second UE to use to transmit to the first UE, transmit, to the second UE at least in part in response to the first set of transmission resources, an indication of a second set of transmission resources for the second UE to use to transmit to the first UE, the second set of transmission resources identified by the first UE based on comparing signals received using the first TRP with signals received using the second TRP, and receive, using the second set of transmission resources, a data message from the second UE via the first sidelink connection.

Some examples of the method, apparatuses, and non-transitory computer-readable medium described herein may further include operations, features, means, or instructions for receiving, from the second UE using the first sidelink connection and at least in part in response to transmitting the indication of the second set of transmission resources, an indication of the second set of transmission resources, where receiving the data message may be based on the received indication of the second set of transmission resources.

In some examples of the method, apparatuses, and non-transitory computer-readable medium described herein, the second set of transmission resources at least partially overlaps in time and frequency with a third set of transmission resources for the third UE to use to transmit to the first UE, the third set of transmission resources based on the second TRP.

In some examples of the method, apparatuses, and non-transitory computer-readable medium described herein, the second set of transmission resources may be spatially division multiplexed with the third set of transmission resources.

In some examples of the method, apparatuses, and non-transitory computer-readable medium described herein, comparing signals received using the first TRP with signals received using the second TRP may include operations, features, means, or instructions for performing a first measurement associated with the first TRP, performing a second measurement associated with the second TRP, and comparing the first measurement and the second measurement to determine the second set of transmission resources.

In some examples of the method, apparatuses, and non-transitory computer-readable medium described herein, the first measurement and the second measurement include RSRP measurements.

Some examples of the method, apparatuses, and non-transitory computer-readable medium described herein may further include operations, features, means, or instructions for determining the second set of transmission resources may be based on a difference between the first measurement and the second measurement satisfying a threshold.

In some examples of the method, apparatuses, and non-transitory computer-readable medium described herein, the indication of the second set of transmission resources includes an indication of a subchannel index, a transmission time, a DMRS port index, or any combination thereof.

In some examples of the method, apparatuses, and non-transitory computer-readable medium described herein, the indication of the second set of transmission resources allocates a first DMRS cyclic shift to the second UE and a second DMRS cyclic shift to the third UE based on the second UE and the third UE communicating via the second set of transmission resources.

In some examples of the method, apparatuses, and non-transitory computer-readable medium described herein, the indication of the second set of transmission resources allocates first interference management resources to the second UE and second interference management resources to the third UE.

In some examples of the method, apparatuses, and non-transitory computer-readable medium described herein, transmitting the indication of the second set of transmission resources may include operations, features, means, or instructions for transmitting sidelink control information to the second UE using the first sidelink connection.

In some examples of the method, apparatuses, and non-transitory computer-readable medium described herein, transmitting the indication of the second set of transmission resources may include operations, features, means, or instructions for broadcasting the indication of the second set of transmission resources to the second UE and the third UE.

In some examples of the method, apparatuses, and non-transitory computer-readable medium described herein, a first group of UEs includes the second UE and a second group of UEs includes the third UE.

Some examples of the method, apparatuses, and non-transitory computer-readable medium described herein may further include operations, features, means, or instructions for transmitting the indication of the second set of transmission resources for the second UE to the first group of UEs, the indication including a group index.

Some examples of the method, apparatuses, and non-transitory computer-readable medium described herein may further include operations, features, means, or instructions for scheduling a fourth UE of the first group of UEs with different resources than the second set of transmission resources.

A method for wireless communication at a second UE is described. The method may include establishing a first sidelink connection with a first UE using a first TRP of the second UE, transmitting, to the first UE using the first sidelink connection, an indication of a first set of transmission resources for the second UE to use to transmit to the first UE, receiving, from the first UE at least in part in response to the first set of transmission resources, an indication of a second set of transmission resources for the second UE to use to transmit to the first UE, and transmitting, at least in part in response to receiving the indication of the second set of transmission resources, a data message to the first UE using the second set of transmission resources.

An apparatus for wireless communication at a second UE is described. The apparatus may include a processor, memory coupled with the processor, and instructions stored in the memory. The instructions may be executable by the processor to cause the apparatus to establish a first sidelink connection with a first UE using a first TRP of the second UE, transmit, to the first UE using the first sidelink connection, an indication of a first set of transmission resources for the second UE to use to transmit to the first UE, receive, from the first UE at least in part in response to the first set of transmission resources, an indication of a second set of transmission resources for the second UE to use to transmit to the first UE, and transmit, at least in part in response to receiving the indication of the second set of transmission resources, a data message to the first UE using the second set of transmission resources.

Another apparatus for wireless communication at a second UE is described. The apparatus may include means for establishing a first sidelink connection with a first UE using a first TRP of the second UE, means for transmitting, to the first UE using the first sidelink connection, an indication of a first set of transmission resources for the second UE to use to transmit to the first UE, means for receiving, from the first UE at least in part in response to the first set of transmission resources, an indication of a second set of transmission resources for the second UE to use to transmit to the first UE, and means for transmitting, at least in part in response to receiving the indication of the second set of transmission resources, a data message to the first UE using the second set of transmission resources.

A non-transitory computer-readable medium storing code for wireless communication at a second UE is described. The code may include instructions executable by a processor to establish a first sidelink connection with a first UE using a first TRP of the second UE, transmit, to the first UE using the first sidelink connection, an indication of a first set of transmission resources for the second UE to use to transmit to the first UE, receive, from the first UE at least in part in response to the first set of transmission resources, an indication of a second set of transmission resources for the second UE to use to transmit to the first UE, and transmit, at least in part in response to receiving the indication of the second set of transmission resources, a data message to the first UE using the second set of transmission resources.

Some examples of the method, apparatuses, and non-transitory computer-readable medium described herein may further include operations, features, means, or instructions for transmitting, to the first UE using the first sidelink connection and at least in part in response to receiving the indication of the second set of transmission resources, an indication of the second set of transmission resources, where transmitting the data message may be based on the transmitted indication of the second set of transmission resources.

In some examples of the method, apparatuses, and non-transitory computer-readable medium described herein, the received indication of the second set of transmission resources includes an indication of a subchannel index, a transmission time, a DMRS port index, or any combination thereof.

In some examples of the method, apparatuses, and non-transitory computer-readable medium described herein, the received indication of the second set of transmission resources allocates a first DMRS cyclic shift to the second UE and a second DMRS cyclic shift to a third UE based on the second UE and the third UE communicating via the second set of transmission resources.

In some examples of the method, apparatuses, and non-transitory computer-readable medium described herein, the received indication of the second set of transmission resources allocates first interference management resources to the second UE and second interference management resources to a third UE.

In some examples of the method, apparatuses, and non-transitory computer-readable medium described herein, receiving the indication of the second set of transmission resources may include operations, features, means, or instructions for receiving sidelink control information from the first UE using the first sidelink connection.

In some examples of the method, apparatuses, and non-transitory computer-readable medium described herein, receiving the indication of the second set of transmission resources may include operations, features, means, or instructions for receiving a broadcast signal from the first UE including the indication of the second set of transmission resources.

In some examples of the method, apparatuses, and non-transitory computer-readable medium described herein, a first group of UEs includes the second UE and a second group of UEs includes the third UE.

In some examples of the method, apparatuses, and non-transitory computer-readable medium described herein, the indication of the second set of transmission resources may be associated with the first group of UEs, the indication including a group index.

### BRIEF DESCRIPTION OF THE DRAWINGS

FIG. 1 illustrates an example of a wireless communications system that supports sidelink user equipment scheduling of spatial division multiplexing receiver with multiple transmission-reception points in accordance with aspects of the present disclosure.

FIG. 2 illustrates an example of a wireless communications system that supports sidelink user equipment scheduling of spatial division multiplexing receiver with multiple transmission-reception points in accordance with aspects of the present disclosure.

FIGS. 3A, 3B, 3C, and 3D illustrate examples of cast types that support sidelink user equipment scheduling of spatial division multiplexing receiver with multiple transmission-reception points in accordance with aspects of the present disclosure.

FIG. 4 illustrates an example of a process flow that supports sidelink user equipment scheduling of spatial division multiplexing receiver with multiple transmission-reception points in accordance with aspects of the present disclosure.

FIG. 5 illustrates an example of a channel structure that supports sidelink user equipment scheduling of spatial division multiplexing receiver with multiple transmission-reception points in accordance with aspects of the present disclosure.

FIG. 6 illustrates an example of a unicast establishment that supports sidelink user equipment scheduling of spatial division multiplexing receiver with multiple transmission-reception points in accordance with aspects of the present disclosure.

FIG. 7 illustrates an example of a process flow that supports sidelink user equipment scheduling of spatial division multiplexing receiver with multiple transmission-reception points in accordance with aspects of the present disclosure.

FIGS. 8 and 9 show block diagrams of devices that support sidelink user equipment scheduling of spatial division multiplexing receiver with multiple transmission-reception points in accordance with aspects of the present disclosure.

FIG. 10 shows a block diagram of a communications manager that supports sidelink user equipment scheduling of spatial division multiplexing receiver with multiple transmission-reception points in accordance with aspects of the present disclosure.

FIG. 11 shows a diagram of a system including a device that supports sidelink user equipment scheduling of spatial division multiplexing receiver with multiple transmission-reception points in accordance with aspects of the present disclosure.

FIGS. 12 through 15 show flowcharts illustrating methods that support sidelink user equipment scheduling of spatial division multiplexing receiver with multiple transmission-reception points in accordance with aspects of the present disclosure.

### DETAILED DESCRIPTION

Some wireless communications systems may support access link communications between a base station and a user equipment (UE). Additionally or alternatively, wireless communications systems may support sidelink communications between multiple wireless devices (e.g., multiple UEs or other wireless devices may communicate via the sidelink communications). For example, in vehicle-to-everything (V2X) communications, two or more vehicles (e.g., two or more UEs) may communicate with each other via broadcast transmissions, groupcast connections, or unicast connections. For the unicast connections, a first UE (e.g., a receiving UE) may establish multiple unicast connections with multiple other UEs (e.g., transmitting UEs), where the multiple other UEs communicate with the first UE via one or more transmission reception points (TRPs) of the first UE. For example, the first UE may be a vehicle and include a first TRP at the front of the vehicle and a second TRP at the rear of the vehicle. Accordingly, the first TRP may be used to communicate with other vehicles in front of the first UE, and the second TRP may be used to communicate with other vehicles behind the first UE. However, as the number of UEs/vehicles increases with which the first UE establishes unicast connections, resources allocated for the V2X communications may become overburdened if communications via the unicast connections each happen at different times or frequencies, and the first UE may not successfully receive or transmit messages with each of the multiple other UEs. Such inefficient resource utilization may result in relatively poor user experience or safety, inefficient communications (e.g., relatively high latency), or both.

In accordance with the techniques described herein, a receiving UE (e.g., a first UE) may implement techniques that enable reliable spatial division multiplexing (SDM) reception. The first UE may schedule SDM communications for one or more UEs in the system. For example, the first UE may indicate resources for SDM communications to other UEs based on measurements associated with multiple TRPs at the first UE (e.g., the first UE may select resources for the SDM communications based on V2X service type and/or directional transmission characteristics with multi-TRPs). That is, the first UE may use the multiple TRPs to perform measurements and enable SDM communications amongst the group of UEs.

As an illustrative example, the first UE may receive sidelink control information (SCI) from the second UE and the third UE via sidelink connections (e.g., a first unicast connection with the second UE and a second unicast connection with the third UE). The first UE may obtain measurements associated with receiving the sidelink control information on each TRP (e.g., reference signal received power (RSRP) measurements, received signal strength indicator (RSSI) measurements, or other measurements of signal power, channel quality, beam conditions, and the like). The first UE may determine that the one or more measurements satisfy a threshold, which may indicate a transmission directionality. For example, the first UE may determine that a signal from one of the UEs may result in a difference between a first measurement (e.g., an RSRP measured at the first TRP) and a second measurement (e.g., an RSRP measured at the second TRP) satisfies a threshold. In such examples, the first UE may determine that the second UE may be suitable for SDM communications on a same set of resources as another UE that may be suitable for the SDM communications (e.g., the third UE).

Accordingly, the first UE may transmit an indication of one or more transmission parameters to the second UE and the third UE. That is, the first UE may schedule the transmitting UEs (e.g., via a set of transmission parameters) to adjust their transmission schedules or resources, transmit powers, and transmit time to enable SDM at the receiving UE (e.g., the first UE) based on the measurements at each TRP. As an illustrative example, the first UE may schedule the second UE and the third UE to use a same set of resources (e.g., the second and third UEs may transmit SDM communications to the first UE on the set of resources), which may improve communications efficiency in the system while maintaining a relatively high signal quality. In some examples, the one or more parameters may include or indicate a demodulation reference signal (DMRS) cyclic shift, channel measurement resources (CMR), interference measurement resources (IMR), a group index associated with the one or more parameters, an indication of the set of resources, a subchannel index, a transmission time, a DMRS port index, or any combination thereof, among other examples of parameters.

As an illustrative example, the second UE may transmit a first SCI message indicating that the second UE has reserved or is attempting to reserve first resources for transmission of a data message. The first UE may schedule the second UE to transmit the data message using second resources that are SDMed with a transmission from another UE in response to the received first SCI message. For example, the first UE may transmit a second SCI message (e.g., a second stage SCI message or a first stage SCI message) indicating the resources. In some cases, the second UE may acknowledge the received second SCI message (e.g., the second UE may transmit another SCI message indicating reservation of the second resources in response to receiving the second SCI message).

Aspects of the disclosure are initially described in the context of wireless communications systems. Additionally, aspects of the disclosure are illustrated by cast types, a channel structure, unicast establishments, a resource pattern, and process flows. Aspects of the disclosure are further illustrated by and described with reference to apparatus diagrams, system diagrams, and flowcharts that relate to sidelink user equipment scheduling of spatial division multiplexing receiver with multiple transmission-reception points.

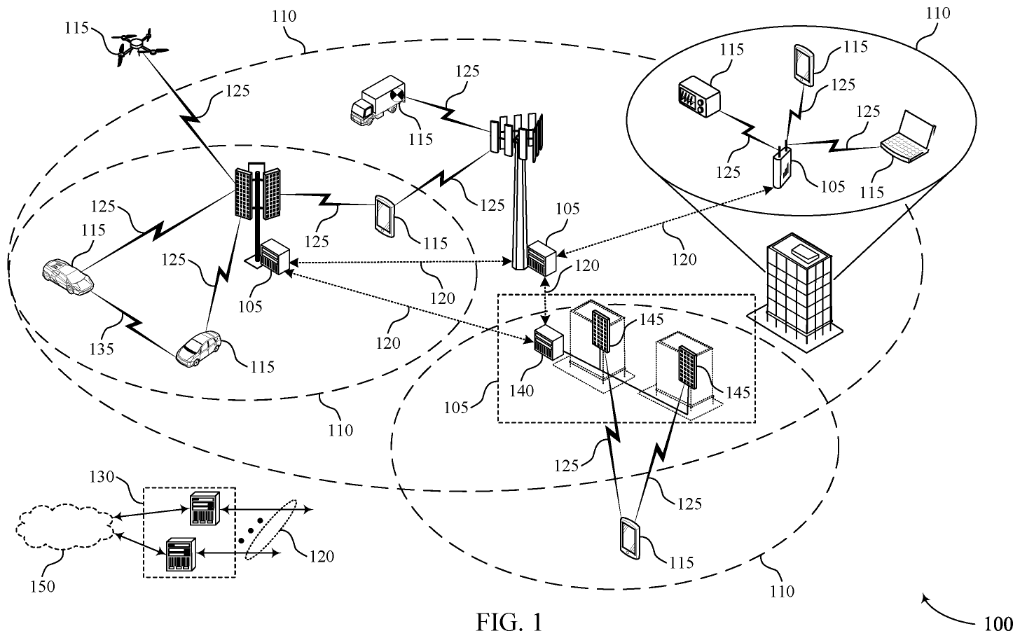

FIG. 1 illustrates an example of a wireless communications system 100 that supports sidelink user equipment scheduling of spatial division multiplexing receiver with multiple transmission-reception points in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

For V2X communications, two or more vehicles (e.g., two or more UEs 115) may communicate with each other via broadcast transmissions, groupcast connections, or unicast connections. For the unicast connections, a first UE 115 (e.g., a receiving UE 115) may establish multiple unicast connections with multiple other UEs 115 (e.g., transmitting UEs 115). However, as the number of UEs/vehicles increases with which the first UE 115 establishes unicast connections, resources allocated for the V2X communications may become overburdened if communications via the unicast connections happen at different times and on different resources in the allocated V2X resources, and the first UE 115 may not successfully receive or transmit messages with each of the multiple other UEs 115, thereby impacting the V2X communications.

Wireless communications system 100 may support an effective use of V2X resources for unicast communications based on a receiving UE 115 (e.g., the first UE 115) coordinating transmissions for multiple transmitting UEs 115 with which the receiving UE 115 has established unicast connections (e.g., unicast links) to enable SDM at the receiving UE 115 for received messages from the multiple transmitting UEs 115 on a same set of time and frequency resources. For example, the receiving UE 115 may establish multiple unicast connections with various transmitting UEs 115 and may determine sets of transmission parameters for each of the transmitting UEs 115 to enable SDM reception at the receiving UE 115 of messages from the transmitting UEs 115. That is, the receiving UE 115 may request or schedule the transmitting UEs 115 (e.g., via transmitting a respective set of transmission parameters to each transmitting UE 115) to adjust their schedules, transmit powers, and transmit time to enable SDM at the receiving UE, where the different transmission parameters are based on power measurements (e.g., RSSI, RSRP, etc.) of each TRP, transmitter UE biased information, or a combination thereof.

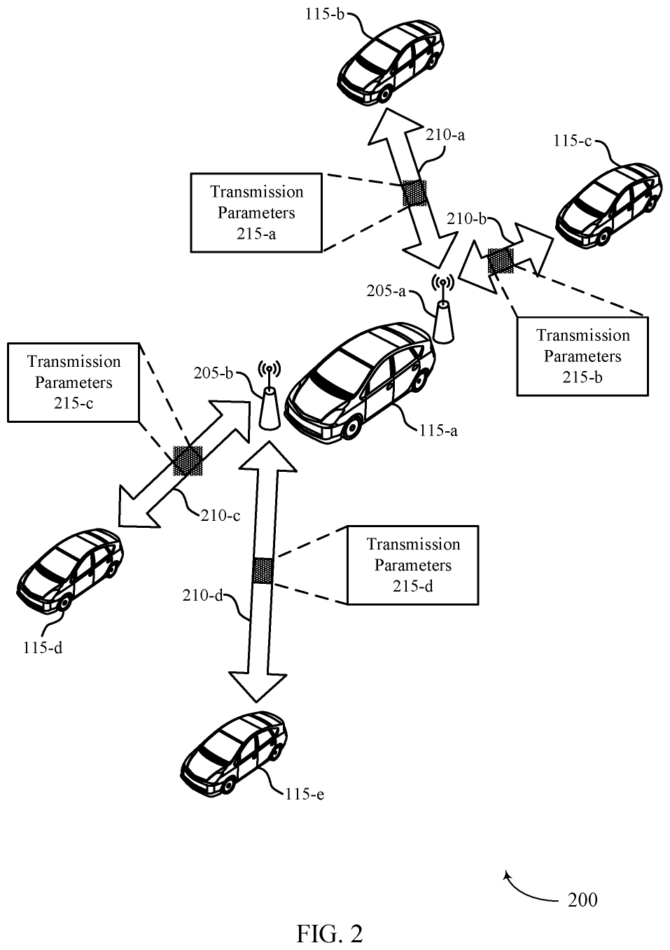

FIG. 2 illustrates an example of a wireless communications system 200 that supports sidelink user equipment scheduling of spatial division multiplexing receiver with multiple transmission-reception points in accordance with aspects of the present disclosure. Wireless communications system 200 may implement aspects of wireless communications system 100. For example, wireless communications system 200 may include multiple UEs 115, such as a receiving UE 115-a, a first transmitting UE 115-b, a second transmitting UE 115-c, a third transmitting UE 115-d, and a fourth transmitting UE 115-e, which may represent examples of UEs 115 as described with reference to FIG. 1. Wireless communications system 200 may also support V2X communications between receiving UE 115-a and the transmitting UEs 115, where the V2X communications may include sidelink communications between the UEs 115. However, while depicted as a V2X system for illustrative clarity, the techniques described herein may be implemented by any wireless communications system, other wireless devices, or a combination thereof. For example, the operations performed at the receiving UE 115 may additionally or alternatively be performed at a transmitting UE 115 or other devices, and vice versa.

The receiving UE 115-a may include multiple TRPs 205 for communications with the different transmitting UEs 115. Multi-TRP sidelink communications may enhance coverage for the communications between receiving UE 115-a and the transmitting UEs 115. Additionally, the multiple TRPs 205 may improve reliability, coverage, and capacity performance through flexible deployment scenarios. More specifically, multiple TRPs 205 equipped in different part of vehicles (e.g., in receiving UE 115-a) may improve reliability in safety and other high robustness desired applications. In some cases, from a transmission point of view, data coverage may be biased. For example, side coverage may not be importance for certain cases (e.g., TRPs located on the side of a vehicle may not provide much value), and front or back biased or 360-degree coverage around the vehicle may be dependent on a packet content or type. From a receiver point of view, the multiple TRPs 205 at the vehicles may desire for 360-degree coverage. As such, receiving UE 115-a may use both TRPs 205 to receive packets from other UEs 115 (e.g., the transmitting UEs 115).

As shown, receiving UE 115-a may include a first TRP 205-a at the rear of the vehicle and a second TRP 205-b at the front of the vehicle. Accordingly, the receiving UE 115-a may receive packets from the first transmitting UE 115-b and the second transmitting UE 115-c via first TRP 205-a and may receive packets from the third transmitting UE 115-d and the fourth transmitting UE 115-e via second TRP 205-b. With each TRP 205, receiving UE 115-a may establish respective unicast connections (e.g., unicast links) with each transmitting UE 115. For example, receiving UE 115-a may establish a first unicast connection 210-a with the first transmitting UE 115-b via first TRP 205-a, a second unicast connection 210-b with the second transmitting UE 115-c via first TRP 205-a, a third unicast connection 210-c with the third transmitting UE 115-d via second TRP 205-b, and a fourth unicast connection 210-d with the fourth transmitting UE 115-e via second TRP 205-b. In some cases, each unicast connection 210 may be referred to as a PC5 unicast link based on the sidelink communications between the receiving UE 115-a and each of the transmitting UEs 115 and that the sidelink communications occur over a PC5 interface.

As described herein, the receiving UE 115-a may schedule one or more of the transmitting UEs 115 with SDM communications over a same set of time frequency resources. In some cases, such techniques may make effective use of V2X resources (e.g., time and frequency resources allocated for the V2X communications) and enable reliable SDM reception using the unicast connections 210 (or other connections 210 such as broadcast connections, connectionless or managed groupless, or other communications schemes). In some implementations, the scheduling may be in view of, for example, a V2X service type and/or directional transmission characteristics based on the multiple TRPs 205. That is, a receiving UE 115-a with multiple TRPs may use measurements associated with the multiple TRPs to schedule the transmitting UEs 115 with SDM transmissions according to transmission directionality (e.g., measured via RSRP in the multiple TRPs 205 of the UE 115-a). In some examples, by coordinating the transmission schedule for the transmitting UEs 115 (e.g., scheduling the transmitting UEs 115), the receiving UE 115-a may be able to receive the packets from the transmitting UEs 115 on a same set of time and frequency resources (e.g., at the same time on a same set of frequencies) using an SDM configuration or scheme. Accordingly, receiving UE 115-a may receive data messages (e.g., data messages such as V2X service data or other data) from the multiple transmitting UEs 115 via the respective unicast connections 210, where the received data messages can be SDMed at receiving UE 115-a from the transmitting UEs 115 according to the transmission directionality (e.g., measured via RSRP, RSSI, and the like) at the receiving UE 115-a.

As an illustrative example, the receiving UE 115-a may receive SCI from the UE 115-b and the UE 115-d via sidelink connections (e.g., unicast connections 210). The receiving UE 115-a may obtain measurements associated with receiving the sidelink control information on each TRP 205. For example, the receiving UE 115-a may receive SCI from the UE 115-b and obtain a first one or more measurements associated with the first TRP 205-a and a second one or more measurements associated with the second TRP 205-b using the received SCI. Such measurements may include RSRP measurements, RSSI measurements, or other measurements of signal power, channel quality, beam conditions, and the like. The receiving UE 115-a may receive SCI from the UE 115-d and obtain a third one or more measurements associated with the first TRP 205-a and a second one or more measurements associated with the second TRP 205-b using the received SCI from the UE 115-d.

The receiving UE 115-a may determine that the one or more measurements satisfy a threshold, which may indicate a transmission directionality. For example, the receiving UE 115-a may determine that a signal from one of the UEs may result in a difference between a first measurement at the first TRP 205-a and a second measurement at the second TRP 205-b satisfies a threshold. For instance, the receiving UE 115-a may determine that a difference between RSRPs (or other measurements) satisfies a threshold. The receiving UE 115-a may be preconfigured with the threshold or another device (e.g., a group leader UE 115 or a base station) may configure the UE 115-a with the threshold. As an example, the receiving UE 115-a may receive signals from the UE 115-b using both TRPs 205-a and 205-b. The receiving UE 115-a may determine that a difference of a first RSRP of the TRP 205-a and a second RSRP of the TRP 205-b satisfies the threshold. The receiving UE 115-a may schedule the UE 115-b for SDM communications based on the satisfied threshold. For example, the receiving UE 115-a may determine that the RSRP is higher at the TRP 205-a for the UE 115-b and that the RSRP is relatively high at the TRP 205-b for the UE 115-d, which may indicate that the UEs 115-b and 115-d may use a same set of resources with a relatively low likelihood of interference. In other words, reception of each link (e.g., unicast connections 210-a and 210-c) may ignore signals from the other link at the other TRP 205 (e.g., the TRP 205-a may ignore or account for signals from the UE 115-d receiving at the TRP 205-b), and thus resource reservation can be shared among multiple links received by different TRPs 205.

Accordingly, the UE 115-a may configure (e.g., schedule) other UEs 115 with SDM communications. For example, the receiving UE 115-a may indicate transmission parameters 215 to the other UEs 115. That is, the first UE may schedule the transmitting UEs 115 (e.g., via a set of transmission parameters 215, respectively) to adjust their transmission schedules or resources, transmit powers, and transmit time to enable SDM at the receiving UE 115-a based on the measurements at each TRP 205. As an example, the UE 115-a may schedule the UE 115-b and the UE 115-d with a same set of resources based on the measurements (e.g., first SDMed transmission data is received in a dedicated TRP 205-a and second SDMed transmission data is received in a dedicated TRP 205-b, which may account for or consider transmission directionality and imbalanced per-TRP power measurement).

In some examples, the one or more parameters may include or indicate the set of resources for SDM transmission. For example, if the receiving UE 115-a receives SCI indicating that the UE 115-d intends to reserve or use a first set of resources and the UE 115-b intends to reserve or use a second set of resources, the UE 115-a may indicate to the UE 115-b to instead use the first set of resources (or indicate to the UE 115-d to use the second set of resources). Additionally or alternatively, the UE 115-a may indicate to use a third set of resources to both the UEs 115-b and 115-d. In any case, the UE 115-a may schedule the UE 115-b and 115-d to use a same set of resources by indicating the set of resources via transmission parameters 215-a to the UE 115-b and transmission parameters 215-c to the UE 115-d. In some examples, the one or more parameters may include or indicate a DMRS cyclic shift, CMR, IMR, a group index associated with the one or more parameters, a subchannel index, a transmission time, a DMRS port index, or any combination thereof, among other examples of parameters.

In some examples, the receiving UE 115-a may be triggered to schedule other UEs 115. For example, the receiving UE 115-a may determine that resource reservation information decoded by pre-SDM receiving procedure (e.g., prior to enabling SDM communications) satisfies one or more thresholds, the UE 115-a may determine that a channel busy ratio measurement satisfies a threshold, the UE 115-a may determine that indications from the UEs 115 indicate possible half duplex conflicts, or any combination thereof among other examples of triggering conditions.

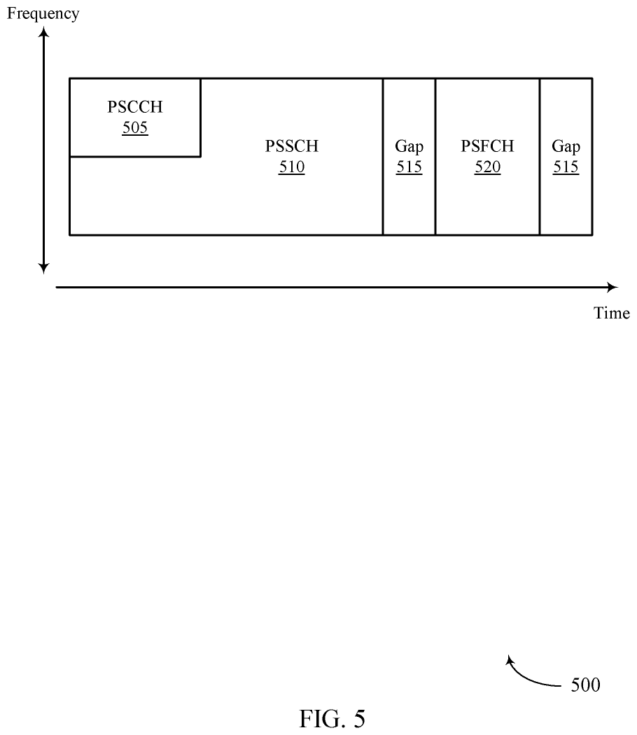

The receiving UE 115-a may instruct resource reservation information and other scheduling information to transmission UEs 115 via one or more signaling schemes. In some examples, the receiving UE 115-a may indicate the transmission parameters 215 (e.g., instruct resource reservation information or other scheduling information) using sidelink control information. For example, the UE 115-a may indicate scheduled time frequency reservation resources to the UE 115 in each unicast link, such that different transmission UEs 115 may use the same or overlapping resources in subsequent unicast transmissions. In some examples, the receiving UE 115-a may indicate scheduling information via a second stage sidelink control information message as described with reference to FIG. 5. Additionally or alternatively, the UE 115-a may broadcast resource reservation information of a respective transmitting UE 115 to the system (in addition or alternative to other information). For example, the UE 115-a may directly broadcast the resource reservation (e.g., of a UE 115-b being scheduled on SDM resources) and other scheduling information in common control information. Such a broadcast may indicate a source identifier (ID) of the reservation/scheduling so that the transmitting UE 115 to which the information corresponds is aware of the update and can adjust a transmission schedule accordingly.

In some examples, the receiving UE 115-a may schedule resources for one or more groups of UEs 115. For example, the UE 115-a may determine multiple groups of UEs 115, such as a first group including the UE 115-b and the UE 115-c and a second group including the UE 115-d and the UE 115-e. For example, the UE 115-a may assign each UE 115 to a respective group based on one or more measurements or parameters (e.g., the UE 115-a may transmit an indication of a group index). In some examples, UEs 115 in a same group may correspond to a same TRP 205. For example, the UE 115-a may receive signals from the UEs 115-d and 115-e using the TRP 205-b. Stated alternatively, for transmission UEs 115 in a same group, a same reception TRP 205 may be used for reception of V2X service data. In some such examples, the UE 115-a may refrain from enabling SDM for UEs 115 in a same group (e.g., to avoid interference when receiving signals at the same TRP 205 for the group of UEs 115). In other words, general resource reservation rules and procedures may be applied when scheduling resources for a same group (e.g., the UE 115-d and the UE 115-e).

In some examples, the UE 115-a may enable SDM transmission for UEs 115 in different groups. For example, the UE 115-b and the UE 115-d may be scheduled with the same resources for communications (e.g., SDM transmission) based on being in different assigned groups (e.g., due to a low expected interference based on measurements at each TRP 205 for the signals received from the UEs 115). In some examples, the receiving UE 115-a may broadcast scheduling or reservation information on a group basis (e.g., the UE 115-a may broadcast stage 1 SCI for each group and indicate a group index and other transmission information via stage 2 SCI).

In some implementations, receiving UE 115-a may determine additional parameters or information for each of the transmitting UEs 115 and transmit these additional parameters or information to each transmitting UE 115 to further enable receiving UE 115-a to receive the packets from the transmitting UEs 115 on the same set of time and frequency resources and enable the SDM reception of the packets. For example, receiving UE 115-a may determine and indicate recommended control DMRS cyclic shifts to each transmitting UE 115, where the recommended control DMRS cyclic shifts may indicate different coding resources for each transmitting UE 115 for enabling reception of the packets at receiving UE 115-a on the colliding time and frequency resources. Additionally or alternatively, receiving UE 115-a may determine and indicate recommended CMR(s) and IMR(s) to each of the transmitting UEs 115, which may enable receiving UE 115 to perform an accurate channel estimation for then combining packets among the multiple TRPs 205.

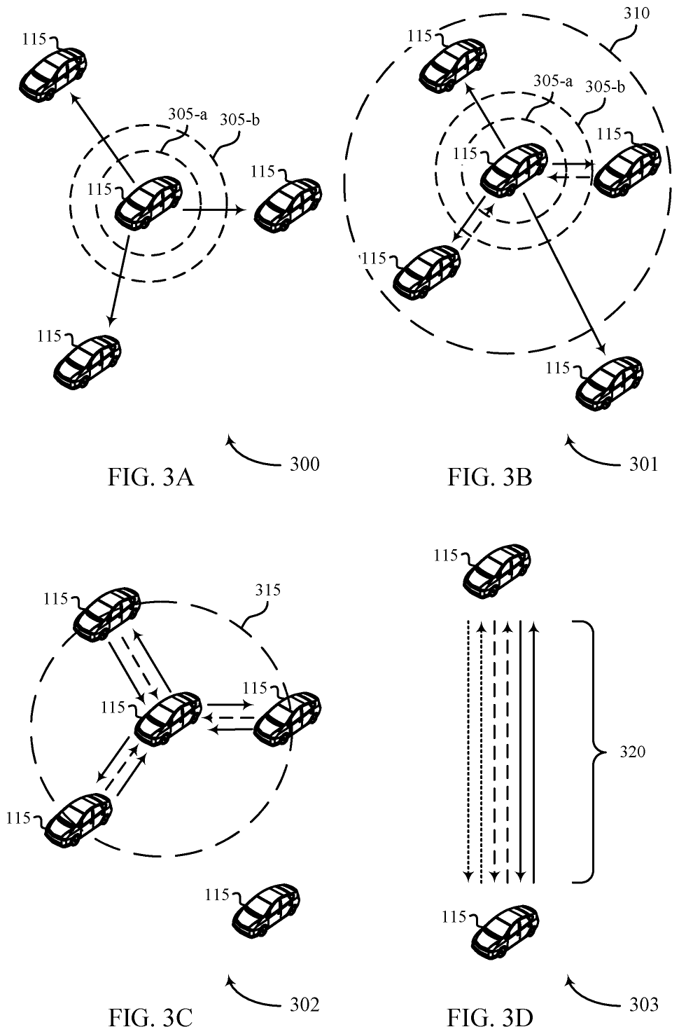

FIGS. 3A, 3B, 3C, and 3D illustrate examples of cast types 300, 301, 302, and 303 in accordance with aspects of the present disclosure. Cast types 300, 301, 302, and 303 may implement aspects of wireless communications systems 100 and 200. For example, cast types 300, 301, 302, and 303 may include one or more UEs 115, where the UEs 115 communicate with each other via sidelinks and V2X communications.

Cast type 300 may represent a broadcast configuration for a UE 115 to transmit V2X packets or information to one or more UEs 115. For example, cast type 300 may include one or more broadcasts 305-a and 305-b that are transmitted by a UE 115 and are available for any nearby UEs 115 to receive. The broadcasts 305 may not be directed or transmitted specifically to any UE 115 and rather may be transmitted in all directions from a UE 115. The broadcasts 305 may include V2X data for nearby UEs 115.

Cast type 301 may represent a connectionless groupcast configuration for a UE 115 to transmit V2X packets or information to one or more UEs 115. The connectionless groupcast configuration may be a negative acknowledgment (NACK) based configuration. For example, a UE 115 may first transmit V2X data out to nearby UEs 115 using broadcasts 305-a and 305-b for a range 310 and may receive a NACK feedback message (e.g., a physical (PHY) layer acknowledgment feedback message) from one or more of the nearby UEs 115 (e.g., indicating the V2X data was unsuccessfully received). Subsequently, the UE 115 may then retransmit the V2X data specifically to those UEs 115 that transmitted the NACK feedback message.

Cast type 302 may represent a managed groupcast configuration for a UE 115 to transmit V2X packets or information to one or more UEs 115. The managed groupcast configuration may be a positive acknowledgment (ACK) based configuration. For example, a UE 115 may first transmit V2X data to a managed group 315 of UEs 115, where after receiving an ACK from one or more UEs 115 in the managed group, the UE 115 may then receive V2X data from the one or more UEs 115.

Cast type 303 may represent a unicast configuration for a UE 115 to transmit V2X packets or information to an additional, single UE 115. With the unicast configuration, the UE 115 and the additional UE 115 may exchange one or more messages 320. For example, the two UEs 115 may first exchange control signaling to establish the unicast connection (e.g., unicast link) via different layers (e.g., PC5 sidelink (PC5-S), PC5-RRC, etc.). Then, the two UEs 115 may exchange acknowledgment feedback to indicate whether the unicast connection was successfully established before then transmitting V2X data between each other.

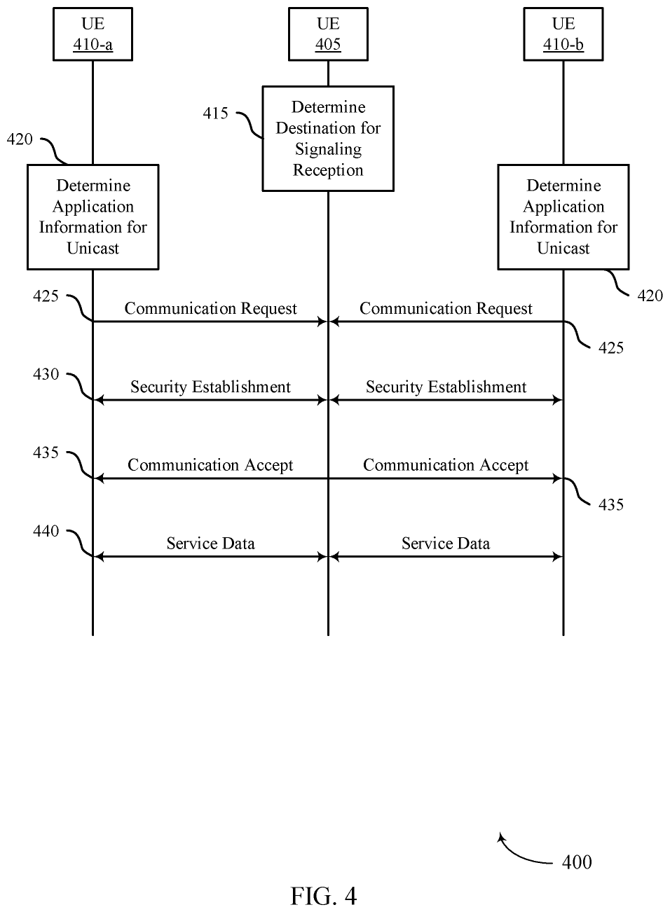

FIG. 4 illustrates an example of a process flow 400 that supports sidelink user equipment scheduling of spatial division multiplexing receiver with multiple transmission-reception points in accordance with aspects of the present disclosure. The process flow 400 may implement aspects of wireless communications systems 100 and 200. For example, the process flow 400 may include a receiving UE 405 and one or more transmitting UEs 410, such as a first transmitting UE 410-a and a second transmitting UE 410-b. The process flow 400 may represent a layer-2 link establishment for multiple unicast connections. For example, receiving UE 405 may establish multiple PC5 unicast connections (e.g., unicast links) with multiple peer UEs 115. That is, both the first transmitting UE 410-a and the second transmitting UE 410-b may establish unicast connections with receiving UE 405 according to the process flow 400 as part of a link establishment procedure.

At 415, receiving UE 405 may determine a destination layer-2 identification for signaling reception. For example, receiving UE 405 may determine the transmitting UEs 410 for signaling reception and identifications of the transmitting UEs 115.

At 420, a V2X application layer of the transmitting UEs 410 may provide application information for the transmitting UEs 410 for a PC5 unicast communication with receiving UE 405. At 425, the transmitting UEs 410 may transmit a direct communication request to receiving UE 405 based on the application information provided by the V2X application layer.

At 430, receiving UE 405 may perform a security establishment with the transmitting UEs 410 based on the direct communication request. At 435, after establishing the security, receiving UE 405 may transmit a direct communication accept message to each transmitting UE 410 via respective unicast connections (e.g., unicast links). Subsequently, at 440, receiving UE 405 and the transmitting UEs 410 may begin transmitting V2X service data to each other over the unicast connections. For example, receiving UE 405 may receive V2X service data from both the first transmitting UE 410-a and the second transmitting UE 410-b with dedicated unicast connections.

FIG. 5 illustrates an example of a channel structure 500 that supports sidelink user equipment scheduling of spatial division multiplexing receiver with multiple transmission-reception points in accordance with aspects of the present disclosure. Channel structure 500 may implement aspects of wireless communications systems 100 and 200. For example, two UEs 115 may communicate with each other using sidelink communications that are configured based on channel structure 500. In some examples, the channel structure 500 may be an example of a physical channel structure (e.g., the channel structure 500 may be used for resource reservation and PHY layer processing). Additionally, physical channel structure 500 may be used for both periodic and aperiodic transmissions. In some cases, a transmission may reserve resources in a current slot and in future slots (e.g., up to two future slots).

The channel structure 500 may include a physical sidelink control channel (PSCCH) 505, a physical sidelink shared channel (PSSCH) 510, one or more gaps 515, and a physical sidelink feedback channel (PSFCH) 520. A first stage control message (e.g., a first SCI message, SCI-1, etc.) may be transmitted on PSCCH 505 and may contain information for resource allocation and for decoding a second stage control message. PSCCH 505 may be limited to a single sub-channel, and a frequency domain orthogonal cover code (FD-OCC) may be applied to DMRS to reduce impact of colliding PSCCH transmissions. In some cases, a transmitter UE 115 may randomly select the FD-OCC from a set of pre-defined FD-OCCs. A second stage control message (e.g., a second SCI message, SCI-2, etc.) may be transmitted on PSSCH 510 and may contain information for decoding data (e.g., shared channel (SCH) transmissions). Accordingly, a receiver UE 115 may decode the SCI first (e.g., both the first stage control message and the second stage control message) and then decode the data. Subsequently, the receiver UE 115 may then transmit feedback (e.g., HARQ feedback) on resources in PSFCH 520 after the gap 515 according to a cast type and a feedback mode.

Accordingly, as described herein, when multiple unicast connections are established between a receiving UE 115 and multiple transmitting UEs 115 and to enable SDM reception of packets from the multiple transmitting UEs 115, the receiving UE 115 may determine transmission parameters (e.g., coordination information) for each of the multiple transmitting UEs 115 and may transmit the determined transmission parameters to the respective transmitting UEs 115 via the second stage control message in PSSCH 510, although other options are possible (e.g., one or more of the parameters may be transmitted via a first stage control message).

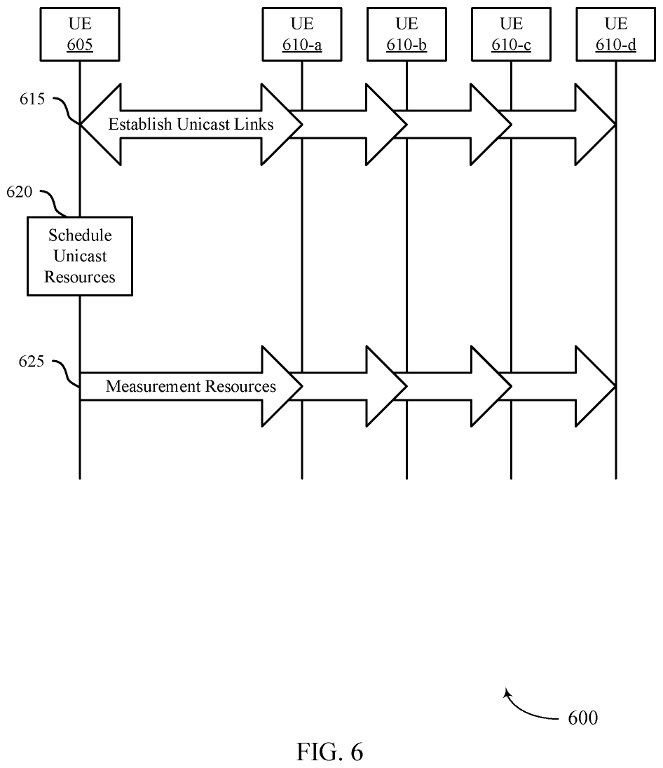

FIG. 6 illustrates an example of a unicast establishment 600 that supports sidelink user equipment scheduling of spatial division multiplexing receiver with multiple transmission-reception points in accordance with aspects of the present disclosure. Unicast establishment 600 may implement aspects of wireless communications systems 100 and 200. For example, unicast establishment 600 may include a receiving UE 605 and one or more transmitting UEs 610, such as a first transmitting UE 610-a, a second transmitting UE 610-b, a third transmitting UE 610-c, and a fourth transmitting UE 610-d.

At 615, receiving UE 605 and each of the transmitting UEs 610 may establish respective unicast links (e.g., unicast connections). For example, the unicast links may be established as described previously with reference to FIG. 4.

At 620, with multiple unicast links established, for SDM reception, in order to decode SCI (e.g., sidelink packets) in colliding time and frequency resources, receiving UE 605 may schedule unicast resources (or other resources) to enable reliable SDM reception with the transmitting UEs 610. Additionally, to enable reliable SDM reception, the receiving UE 605 may indicate one or more parameters to each SDMed transmitting UE 610. For example, the UE 605 may allocate a DMRS cyclic shift, CMR, IMR, or other parameters to each SDMed transmission UE 610.

By allocating a DMRS cyclic shift to each UE 610 that is to use overlapping or same resources for SDM reception at the UE 605, the receiving UE 605 may enable relatively accurate channel and signal to interference plus noise ratio (SINR) estimation. Stated alternatively, the receiving UE 605 may instruct or schedule cyclic shift used for SCI transmission to avoid resource collision leading to detection failure. In some examples, the control DMRS cyclic shift may be used to differentiate coding resources among various SDMed transmission UEs 610. In some examples, the DMRS cyclic shift for a respective UE 610 may be indicated via a second stage SCI.

Additionally or alternatively, the receiving UE 605 may allocate IMR, CMR, or both to one or more transmissions UEs 610 that are SDMed (e.g., scheduled to transmit on a same or overlapping set of resources). The recommended CMR and IMR may enable receiving UE 605 to yield accurate channel or SINR estimation for reception combining among multiple TRPs located in receiving UE 605 or to decide if reception combining is doable. For example, receiving UE 605 may use the recommend CMR and IMR as part of estimating channel and interference levels at colliding time and frequency resources used by the SDMed transmitting UEs 610 among the multiple TRPs located in receiving UE 605. In some implementation, receiving UE 605 may transmit this indication of the CMR and IMR via a second stage SCI as part of UE coordination information.

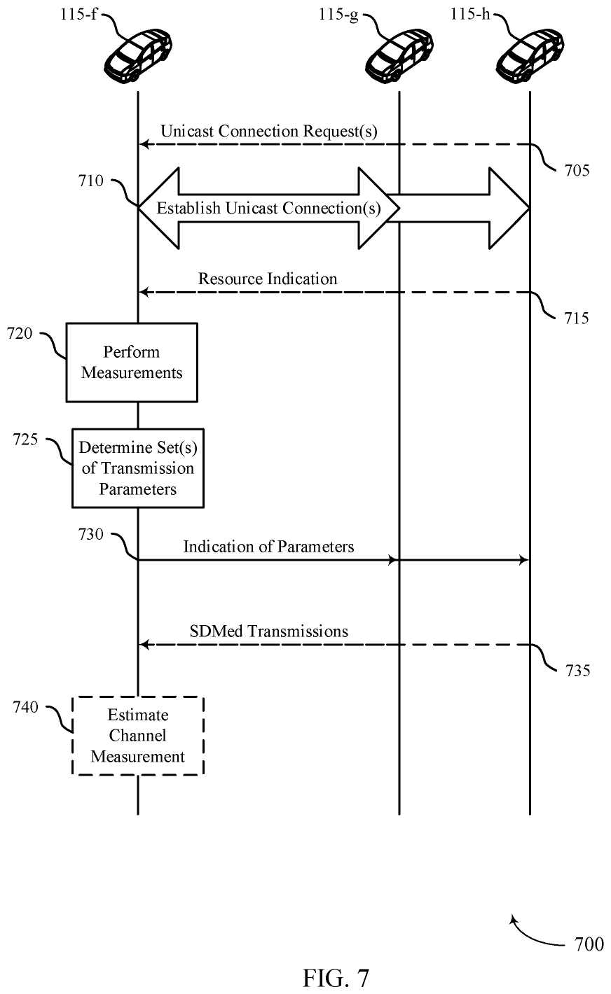

FIG. 7 illustrates an example of a process flow 700 that supports sidelink user equipment scheduling of spatial division multiplexing receiver with multiple transmission-reception points in accordance with aspects of the present disclosure. Process flow 700 may implement aspects of wireless communications systems 100 and 200. For example, process flow 700 may include a receiving UE 115-f and one or more transmitting UEs 115, such as a transmitting UE 115-g and a transmitting UE 115-h.

In the following description of the process flow 700, the operations between the receiving UE 115-f, the transmitting UE 115-g, and the transmitting UE 115-h may be transmitted in a different order than the exemplary order shown, or the operations performed by the receiving UE 115-f, the transmitting UE 115-g, and the transmitting UE 115-h may be performed in different orders or at different times. Certain operations may also be left out of the process flow 700, or other operations may be added to the process flow 700. It is to be understood that while the receiving UE 115-f, the transmitting UE 115-g, and the transmitting UE 115-h are shown performing a number of the operations of process flow 700, any wireless device may perform the operations shown. For example, while depicted as vehicles for illustrative clarity, the UEs 115 may be any example of a wireless device.

In some examples, at 705 the transmitting UE 115-g and the transmitting UE 115-h may transmit, to the receiving UE 115-f, a request to establish a unicast connection (e.g., unicast connection requests) with the receiving UE 115-f. For example, the transmitting UE 115-g may establish a unicast connection with a first TRP of multiple TRPs of the receiving UE 115-f.

At 710, the receiving UE 115-f may establish a set of unicast connections (or other connections) with multiple transmitting UEs 115 including the transmitting UE 115-g and the transmitting UE 115-h (e.g., based on the request to establish the unicast connection). In some cases, the multiple transmitting UEs 115 may include one or more first transmitting UEs 115 connected to the first TRP of the receiving UE 115-f via respective unicast connections of the set of unicast connections (e.g., a first group of transmitting UEs 115) and one or more second transmitting UEs 115 connected to a second TRP of the receiving UE 115-f via respective unicast connections of the set of unicast connections (e.g., a second group of transmitting UEs 115). In some implementations, the receiving UE 115-f may select the multiple transmitting UEs 115 for establishing the set of unicast connections based on detecting an SCI message from each of the multiple transmitting UEs 115 (e.g., the unicast connection requests), performing a signal quality measurement among the first TRP and the second TRP of the receiving UE 115-f for each transmitting UE 115, or a combination thereof.

In some examples, at 715 the UE 115-h, the UE 115-g, or both may reserve resources for a data message transmission or other SCI transmissions. For example, the UE 115-g may indicate a first set of resources (e.g., a set of resources the UE 115-g intends to use for transmission of a data message). In some examples, the resource indication may be an example of an SCI message for a resource reservation as described herein. Additionally or alternatively, the UE 115-h may indicate a different set of resources (e.g., a set of resources the UE 115-h intends to use for transmission of a data message).

At 720, the receiving UE 115-f may perform one or more measurements. For example, the UE 115-f may receive signals (e.g., the resource indication or other signals such as reference signals) and determine a RSRP (or another measurement) for each TRP of the UE 115-f using the signals. In some examples, the UE 115-f may determine that the one or more measurements satisfies a threshold (e.g., a difference between the measurements for the UE 115-g, the UE 115-h, or both satisfies a threshold as described herein with reference to FIG. 2).

At 725, the receiving UE 115-f may determine one or more sets of transmission parameters for the multiple transmitting UEs 115, where the one or more sets of transmission parameters may enable the receiving UE 115-f to receive transmissions from the multiple transmitting UEs 115 on a same or overlapping set of time and frequency resources via an SDM scheme. In some implementations, the receiving UE 115-f may determine the one or more sets of transmission parameters for the respective transmitting UEs of the multiple transmitting UEs based on which TRP of the receiving UE 115-f is used for a respective unicast connection with a transmitting UE 115 of the multiple transmitting UEs. Additionally, a same set of transmission parameters may be used for a first transmitting UE 115 and for a second transmitting UE 115 of the multiple transmitting UEs 115 based on a first unicast connection being established between the first transmitting UE 115 and the receiving UE 115-f via the first TRP and a second unicast connection being established between the second transmitting UE 115 and the receiving UE 115-f via the second TRP.

In some implementations, the receiving UE 115-f may determine the one or more sets of transmission parameters based on one or more signal quality measurements of the set of unicast connections (e.g., the measurements performed at 720). For example, the one or more signal quality measurements may include an RSSI measurement, an RSRP measurement, biased information for each of the multiple transmitting UEs 115, or a combination thereof. As an example, the receiving UE 115-f may perform a first measurement on a first TRP and a second measurement on a second TRP as described herein. If the measurements (e.g., a difference between the measurements) satisfies a threshold, the UE 115-f may determine that a corresponding UE 115 is a candidate for SDM transmission with another UE 115. In some examples, the parameters may include or indicate a DMRS cyclic shift, CMR, IMR, a group index, a subchannel index, a transmission time, a DMRS port index, or any combination thereof, among other examples of parameters.

At 730, the receiving UE 115-f may transmit each set of transmission parameters from the one or more sets of transmission parameters to respective transmitting UEs 115 of the multiple transmitting UEs 115. For example, the receiving UE 115-f may indicate a set of resources for SDM transmission to the UE 115-g, the UE 115-h, or both as described herein with reference to FIG. 2 (e.g., via unicast, broadcast, etc.). In some examples, the indication may be in response to the resource indication at 715. In some implementations, the receiving UE 115-f may transmit each set of transmission parameters via an SCI message to the respective transmitting UEs 115. For example, each set of transmission parameters may be indicated via a resource bit map in the SCI message. Additionally or alternatively, the SCI message may be a second stage SCI message. In some examples, the receiving UE 115-f may broadcast or unicast the indication of the transmission parameters.

At 725, the receiving UE 115-f may transmit, to the respective transmitting UEs 115, an indication for a control DMRS cyclic shift for each transmitting UE 115 to use when transmitting communications to the receiving UE 115-f, where the control DMRS cyclic shift further enables the receiving UE 115-f to receive the transmissions from the multiple transmitting UEs 115 on the same set of time and frequency resources via the SDM scheme. In some implementations, the receiving UE 115-f may transmit the indication for the control DMRS cyclic shift to the respective transmitting UEs 115 via an SCI message. For example, the SCI message may be a second stage SCI message for UE coordination.

In some examples, at 735 the receiving UE 115-f may receive one or more SDMed transmissions from the multiple transmitting UEs 115 based on the plurality of sets of transmission parameters. For example, the receiving UE 115-f may receive a first data message from the UE 115-g on a set of resources (e.g., indicated by the one or more parameters) and a second data message from the UE 115-h on the same or overlapping set of resources in accordance with an SDM scheme. In some examples, the UE 115-g, the UE 115-h, or both may retransmit a resource indication or acknowledge the indication of parameters prior to transmitting the SDMed transmissions. For example, the UE 115-g may receive an indication of a set of resources to use from the UE 115-f and the UE 115-g may transmit another SCI message indicating the updated set of resources to other UEs 115 in the system. Additionally or alternatively, the UE 115-g may transmit an ACK to the UE 115-f in response to receiving the indication of the parameters.

In some examples, at 740 the receiving UE 115-f may estimate a channel measurement, an interference measurement, or the like per TRP for transmissions from the multiple transmitting UEs 115 on the same set of time and frequency resources based on the indication of the CMR, the IMR, the DMRS cyclic shift, or any combination as described herein.

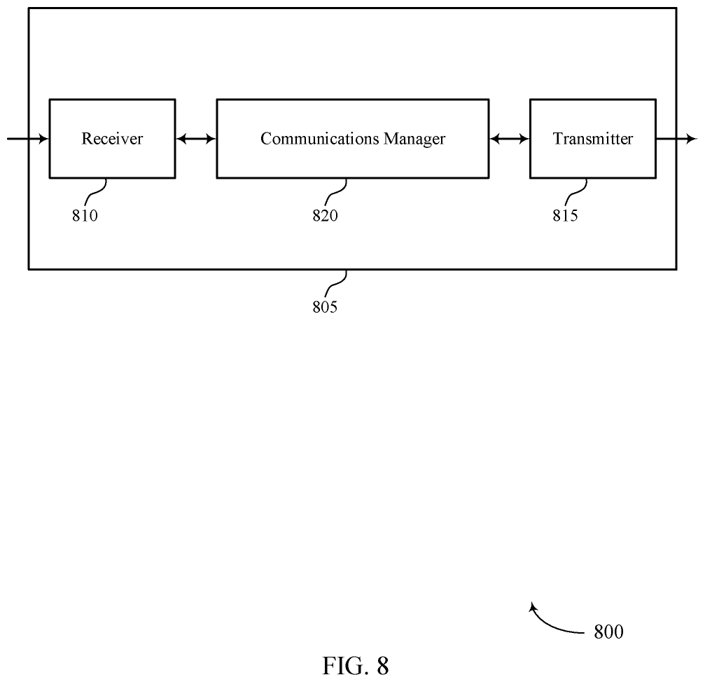

FIG. 8 shows a block diagram 800 of a device 805 that supports sidelink user equipment scheduling of spatial division multiplexing receiver with multiple transmission-reception points in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to sidelink user equipment scheduling of spatial division multiplexing receiver with multiple transmission-reception points). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to sidelink user equipment scheduling of spatial division multiplexing receiver with multiple transmission-reception points). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of sidelink user equipment scheduling of spatial division multiplexing receiver with multiple transmission-reception points as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a first UE in accordance with examples as disclosed herein. For example, the communications manager 820 may be configured as or otherwise support a means for establishing a first sidelink connection with a second UE and a second sidelink connection with a third UE, the first sidelink connection using a first transmission reception point of the first UE, and the second sidelink connection using a second transmission reception point of the first UE. The communications manager 820 may be configured as or otherwise support a means for receiving, from the second UE using the first sidelink connection, an indication of a first set of transmission resources for the second UE to use to transmit to the first UE. The communications manager 820 may be configured as or otherwise support a means for transmitting, to the second UE at least in part in response to the first set of transmission resources, an indication of a second set of transmission resources for the second UE to use to transmit to the first UE, the second set of transmission resources identified by the first UE based on comparing signals received using the first transmission reception point with signals received using the second transmission reception point. The communications manager 820 may be configured as or otherwise support a means for receiving, using the second set of transmission resources, a data message from the second UE via the first sidelink connection.

Additionally or alternatively, the communications manager 820 may support wireless communication at a second UE in accordance with examples as disclosed herein. For example, the communications manager 820 may be configured as or otherwise support a means for establishing a first sidelink connection with a first UE using a first transmission reception point of the second UE. The communications manager 820 may be configured as or otherwise support a means for transmitting, to the first UE using the first sidelink connection, an indication of a first set of transmission resources for the second UE to use to transmit to the first UE. The communications manager 820 may be configured as or otherwise support a means for receiving, from the first UE at least in part in response to the first set of transmission resources, an indication of a second set of transmission resources for the second UE to use to transmit to the first UE. The communications manager 820 may be configured as or otherwise support a means for transmitting, at least in part in response to receiving the indication of the second set of transmission resources, a data message to the first UE using the second set of transmission resources.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for more efficient utilization of communication resources (e.g., V2X resources) by receiving multiple transmissions from multiple UEs via an SDM scheme based on determined transmission parameters indicated to each of the multiple UEs.

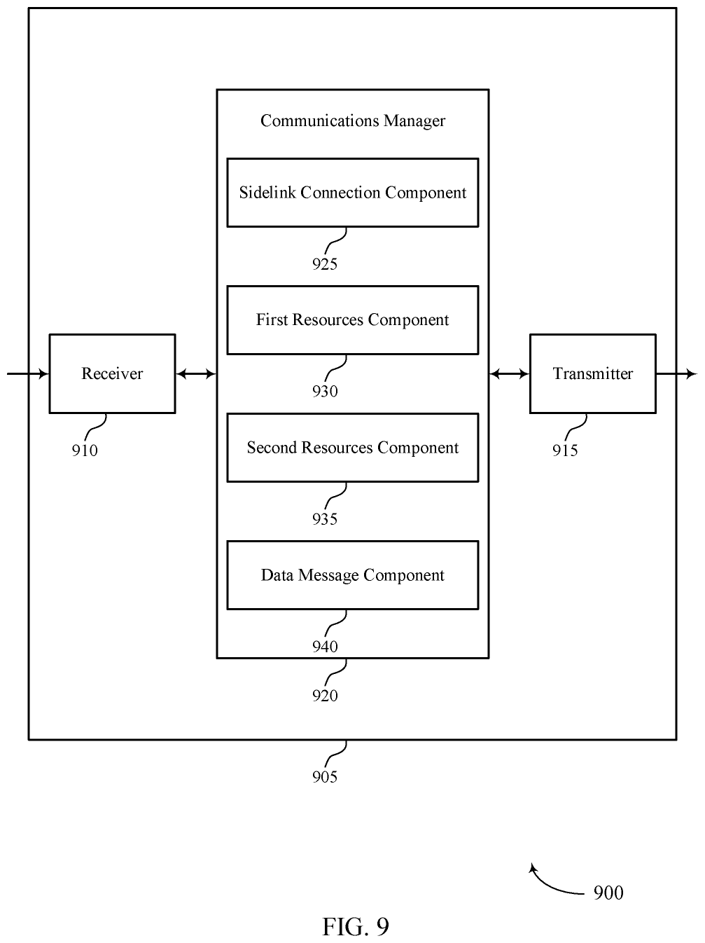

FIG. 9 shows a block diagram 900 of a device 905 that supports sidelink user equipment scheduling of spatial division multiplexing receiver with multiple transmission-reception points in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink user equipment scheduling of spatial division multiplexing receiver with multiple transmission-reception points). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink user equipment scheduling of spatial division multiplexing receiver with multiple transmission-reception points). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of sidelink user equipment scheduling of spatial division multiplexing receiver with multiple transmission-reception points as described herein. For example, the communications manager 920 may include a sidelink connection component 925, a first resources component 930, a second resources component 935, a data message component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a first UE in accordance with examples as disclosed herein. The sidelink connection component 925 may be configured as or otherwise support a means for establishing a first sidelink connection with a second UE and a second sidelink connection with a third UE, the first sidelink connection using a first transmission reception point of the first UE, and the second sidelink connection using a second transmission reception point of the first UE. The first resources component 930 may be configured as or otherwise support a means for receiving, from the second UE using the first sidelink connection, an indication of a first set of transmission resources for the second UE to use to transmit to the first UE. The second resources component 935 may be configured as or otherwise support a means for transmitting, to the second UE at least in part in response to the first set of transmission resources, an indication of a second set of transmission resources for the second UE to use to transmit to the first UE, the second set of transmission resources identified by the first UE based on comparing signals received using the first transmission reception point with signals received using the second transmission reception point. The data message component 940 may be configured as or otherwise support a means for receiving, using the second set of transmission resources, a data message from the second UE via the first sidelink connection.

Additionally or alternatively, the communications manager 920 may support wireless communication at a second UE in accordance with examples as disclosed herein. The sidelink connection component 925 may be configured as or otherwise support a means for establishing a first sidelink connection with a first UE using a first transmission reception point of the second UE. The first resources component 930 may be configured as or otherwise support a means for transmitting, to the first UE using the first sidelink connection, an indication of a first set of transmission resources for the second UE to use to transmit to the first UE. The second resources component 935 may be configured as or otherwise support a means for receiving, from the first UE at least in part in response to the first set of transmission resources, an indication of a second set of transmission resources for the second UE to use to transmit to the first UE. The data message component 940 may be configured as or otherwise support a means for transmitting, at least in part in response to receiving the indication of the second set of transmission resources, a data message to the first UE using the second set of transmission resources.

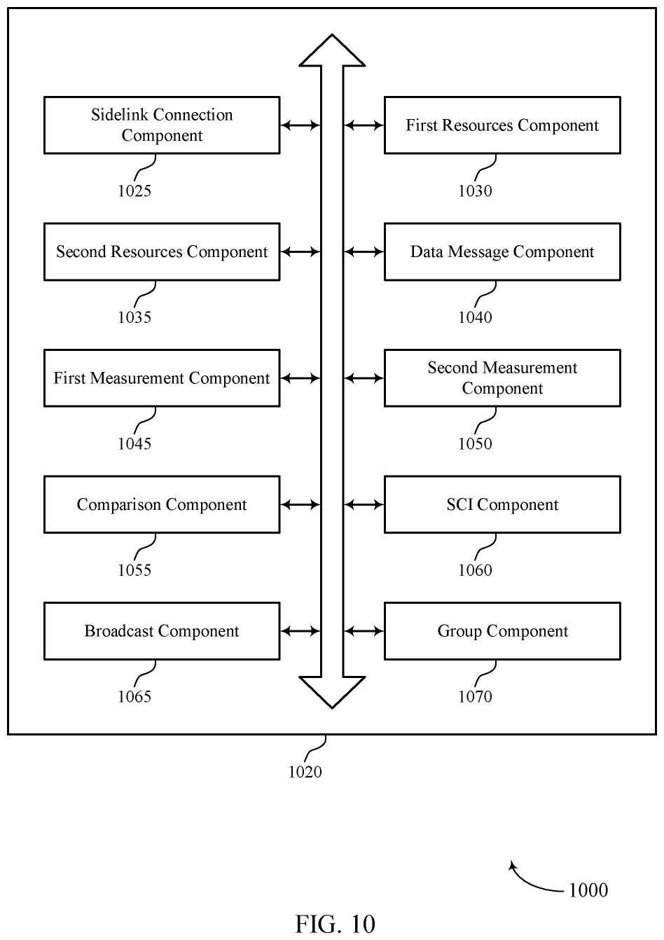

FIG. 10 shows a block diagram 1000 of a communications manager 1020 that supports sidelink user equipment scheduling of spatial division multiplexing receiver with multiple transmission-reception points in accordance with aspects of the present disclosure. The communications manager 1020 may be an example of aspects of a communications manager 820, a communications manager 920, or both, as described herein. The communications manager 1020, or various components thereof, may be an example of means for performing various aspects of sidelink user equipment scheduling of spatial division multiplexing receiver with multiple transmission-reception points as described herein. For example, the communications manager 1020 may include a sidelink connection component 1025, a first resources component 1030, a second resources component 1035, a data message component 1040, a first measurement component 1045, a second measurement component 1050, a comparison component 1055, an SCI component 1060, a broadcast component 1065, a group component 1070, or any combination thereof. Each of these components may communicate, directly or indirectly, with one another (e.g., via one or more buses).

The communications manager 1020 may support wireless communications at a first UE in accordance with examples as disclosed herein. The sidelink connection component 1025 may be configured as or otherwise support a means for establishing a first sidelink connection with a second UE and a second sidelink connection with a third UE, the first sidelink connection using a first transmission reception point of the first UE, and the second sidelink connection using a second transmission reception point of the first UE. The first resources component 1030 may be configured as or otherwise support a means for receiving, from the second UE using the first sidelink connection, an indication of a first set of transmission resources for the second UE to use to transmit to the first UE. The second resources component 1035 may be configured as or otherwise support a means for transmitting, to the second UE at least in part in response to the first set of transmission resources, an indication of a second set of transmission resources for the second UE to use to transmit to the first UE, the second set of transmission resources identified by the first UE based on comparing signals received using the first transmission reception point with signals received using the second transmission reception point. The data message component 1040 may be configured as or otherwise support a means for receiving, using the second set of transmission resources, a data message from the second UE via the first sidelink connection.

In some examples, the second resources component 1035 may be configured as or otherwise support a means for receiving, from the second UE using the first sidelink connection and at least in part in response to transmitting the indication of the second set of transmission resources, an indication of the second set of transmission resources, where receiving the data message is based on the received indication of the second set of transmission resources. In some examples, the second set of transmission resources at least partially overlaps in time and frequency with a third set of transmission resources for the third UE to use to transmit to the first UE, the third set of transmission resources based on the second transmission reception point. In some examples, the second set of transmission resources are spatially division multiplexed with the third set of transmission resources.

In some examples, to support comparing signals received using the first transmission reception point with signals received using the second transmission reception point, the first measurement component 1045 may be configured as or otherwise support a means for performing a first measurement associated with the first transmission reception point. In some examples, to support comparing signals received using the first transmission reception point with signals received using the second transmission reception point, the second measurement component 1050 may be configured as or otherwise support a means for performing a second measurement associated with the second transmission reception point. In some examples, to support comparing signals received using the first transmission reception point with signals received using the second transmission reception point, the comparison component 1055 may be configured as or otherwise support a means for comparing the first measurement and the second measurement to determine the second set of transmission resources.

In some examples, the first measurement and the second measurement include reference signal received power measurements. In some examples, determining the second set of transmission resources is based on a difference between the first measurement and the second measurement satisfying a threshold. In some examples, the indication of the second set of transmission resources includes an indication of a subchannel index, a transmission time, a demodulation reference signal port index, or any combination thereof. In some examples, the indication of the second set of transmission resources allocates a first demodulation reference signal cyclic shift to the second UE and a second demodulation reference signal cyclic shift to the third UE based on the second UE and the third UE communicating via the second set of transmission resources. In some examples, the indication of the second set of transmission resources allocates first interference management resources to the second UE and second interference management resources to the third UE.

In some examples, to support transmitting the indication of the second set of transmission resources, the SCI component 1060 may be configured as or otherwise support a means for transmitting sidelink control information to the second UE using the first sidelink connection.

In some examples, to support transmitting the indication of the second set of transmission resources, the broadcast component 1065 may be configured as or otherwise support a means for broadcasting the indication of the second set of transmission resources to the second UE and the third UE. In some examples, a first group of UEs includes the second UE and a second group of UEs includes the third UE.

In some examples, the group component 1070 may be configured as or otherwise support a means for transmitting the indication of the second set of transmission resources for the second UE to the first group of UEs, the indication including a group index. In some examples, the group component 1070 may be configured as or otherwise support a means for scheduling a fourth UE of the first group of UEs with different resources than the second set of transmission resources.

Additionally or alternatively, the communications manager 1020 may support wireless communication at a second UE in accordance with examples as disclosed herein. In some examples, the sidelink connection component 1025 may be configured as or otherwise support a means for establishing a first sidelink connection with a first UE using a first transmission reception point of the second UE. In some examples, the first resources component 1030 may be configured as or otherwise support a means for transmitting, to the first UE using the first sidelink connection, an indication of a first set of transmission resources for the second UE to use to transmit to the first UE. In some examples, the second resources component 1035 may be configured as or otherwise support a means for receiving, from the first UE at least in part in response to the first set of transmission resources, an indication of a second set of transmission resources for the second UE to use to transmit to the first UE. In some examples, the data message component 1040 may be configured as or otherwise support a means for transmitting, at least in part in response to receiving the indication of the second set of transmission resources, a data message to the first UE using the second set of transmission resources.

In some examples, the second resources component 1035 may be configured as or otherwise support a means for transmitting, to the first UE using the first sidelink connection and at least in part in response to receiving the indication of the second set of transmission resources, an indication of the second set of transmission resources, where transmitting the data message is based on the transmitted indication of the second set of transmission resources. In some examples, the received indication of the second set of transmission resources includes an indication of a subchannel index, a transmission time, a demodulation reference signal port index, or any combination thereof.

In some examples, the received indication of the second set of transmission resources allocates a first demodulation reference signal cyclic shift to the second UE and a second demodulation reference signal cyclic shift to a third UE based on the second UE and the third UE communicating via the second set of transmission resources. In some examples, the received indication of the second set of transmission resources allocates first interference management resources to the second UE and second interference management resources to a third UE.

In some examples, to support receiving the indication of the second set of transmission resources, the SCI component 1060 may be configured as or otherwise support a means for receiving sidelink control information from the first UE using the first sidelink connection. In some examples, to support receiving the indication of the second set of transmission resources, the broadcast component 1065 may be configured as or otherwise support a means for receiving a broadcast signal from the first UE including the indication of the second set of transmission resources.

In some examples, a first group of UEs includes the second UE and a second group of UEs includes the third UE. In some examples, the indication of the second set of transmission resources is associated with the first group of UEs, the indication including a group index.

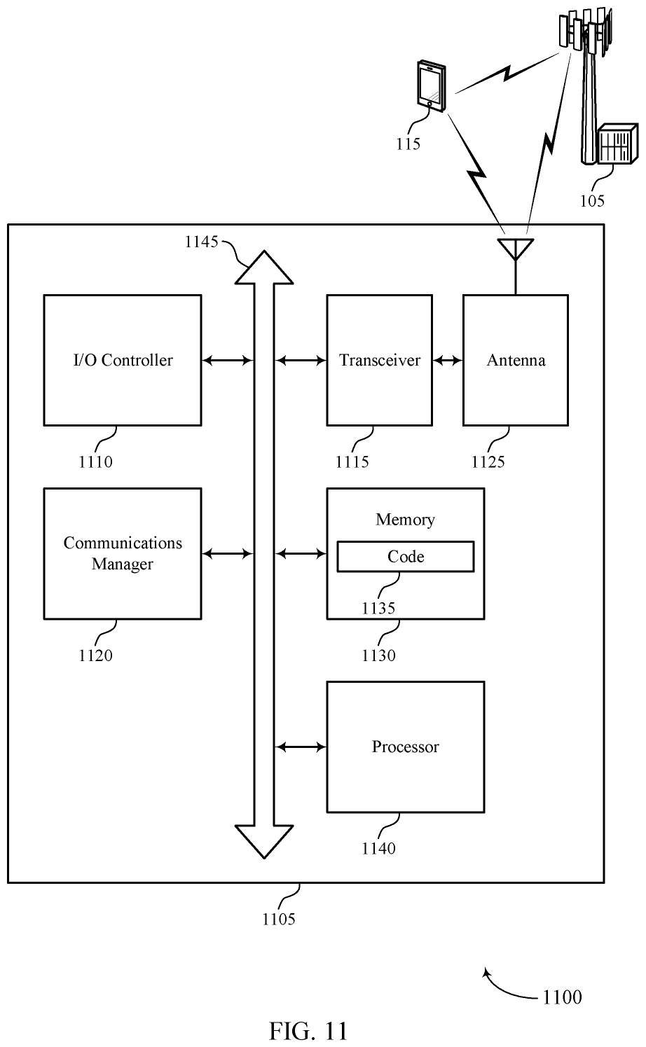

FIG. 11 shows a diagram of a system 1100 including a device 1105 that supports sidelink user equipment scheduling of spatial division multiplexing receiver with multiple transmission-reception points in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting sidelink user equipment scheduling of spatial division multiplexing receiver with multiple transmission-reception points). For example, the device 1105 or a component of the device 1105 may include a processor 1140 and memory 1130 coupled to the processor 1140, the processor 1140 and memory 1130 configured to perform various functions described herein.

The communications manager 1120 may support wireless communications at a first UE in accordance with examples as disclosed herein. For example, the communications manager 1120 may be configured as or otherwise support a means for establishing a first sidelink connection with a second UE and a second sidelink connection with a third UE, the first sidelink connection using a first transmission reception point of the first UE, and the second sidelink connection using a second transmission reception point of the first UE. The communications manager 1120 may be configured as or otherwise support a means for receiving, from the second UE using the first sidelink connection, an indication of a first set of transmission resources for the second UE to use to transmit to the first UE. The communications manager 1120 may be configured as or otherwise support a means for transmitting, to the second UE at least in part in response to the first set of transmission resources, an indication of a second set of transmission resources for the second UE to use to transmit to the first UE, the second set of transmission resources identified by the first UE based on comparing signals received using the first transmission reception point with signals received using the second transmission reception point. The communications manager 1120 may be configured as or otherwise support a means for receiving, using the second set of transmission resources, a data message from the second UE via the first sidelink connection.

Additionally or alternatively, the communications manager 1120 may support wireless communication at a second UE in accordance with examples as disclosed herein. For example, the communications manager 1120 may be configured as or otherwise support a means for establishing a first sidelink connection with a first UE using a first transmission reception point of the second UE. The communications manager 1120 may be configured as or otherwise support a means for transmitting, to the first UE using the first sidelink connection, an indication of a first set of transmission resources for the second UE to use to transmit to the first UE. The communications manager 1120 may be configured as or otherwise support a means for receiving, from the first UE at least in part in response to the first set of transmission resources, an indication of a second set of transmission resources for the second UE to use to transmit to the first UE. The communications manager 1120 may be configured as or otherwise support a means for transmitting, at least in part in response to receiving the indication of the second set of transmission resources, a data message to the first UE using the second set of transmission resources.

By including or configuring the communications manager 1120 in accordance with examples as described herein, the device 1105 may support techniques for improved communication reliability, more efficient utilization of communication resources, and improved coordination between devices. For example, the determined sets of transmission parameters may enable multiple transmitting UEs to use a same set of time and frequency resources (e.g., more efficient use of communication resources) when transmitting messages to the receiving UE, where the receiving UE receives the messages according to an SDM scheme based on the sets of transmission parameters. Additionally, the determined sets of transmission parameters may decrease chances that the messages interfere with each other, thereby improving reliability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of sidelink user equipment scheduling of spatial division multiplexing receiver with multiple transmission-reception points as described herein, or the processor 1140 and the memory 1130 may be otherwise configured to perform or support such operations.

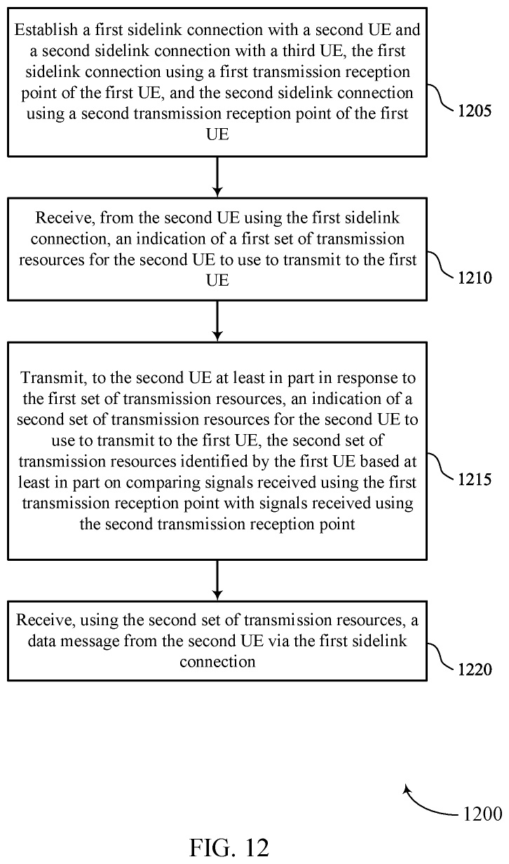

FIG. 12 shows a flowchart illustrating a method 1200 that supports sidelink user equipment scheduling of spatial division multiplexing receiver with multiple transmission-reception points in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include establishing a first sidelink connection with a second UE and a second sidelink connection with a third UE, the first sidelink connection using a first transmission reception point of the first UE, and the second sidelink connection using a second transmission reception point of the first UE. The operations of 1205 may be performed in accordance with examples as disclosed herein. In some examples, aspects of the operations of 1205 may be performed by a sidelink connection component 1025 as described with reference to FIG. 10.

At 1210, the method may include receiving, from the second UE using the first sidelink connection, an indication of a first set of transmission resources for the second UE to use to transmit to the first UE. The operations of 1210 may be performed in accordance with examples as disclosed herein. In some examples, aspects of the operations of 1210 may be performed by a first resources component 1030 as described with reference to FIG. 10.

At 1215, the method may include transmitting, to the second UE at least in part in response to the first set of transmission resources, an indication of a second set of transmission resources for the second UE to use to transmit to the first UE, the second set of transmission resources identified by the first UE based on comparing signals received using the first transmission reception point with signals received using the second transmission reception point. The operations of 1215 may be performed in accordance with examples as disclosed herein. In some examples, aspects of the operations of 1215 may be performed by a second resources component 1035 as described with reference to FIG. 10.

At 1220, the method may include receiving, using the second set of transmission resources, a data message from the second UE via the first sidelink connection. The operations of 1220 may be performed in accordance with examples as disclosed herein. In some examples, aspects of the operations of 1220 may be performed by a data message component 1040 as described with reference to FIG. 10.

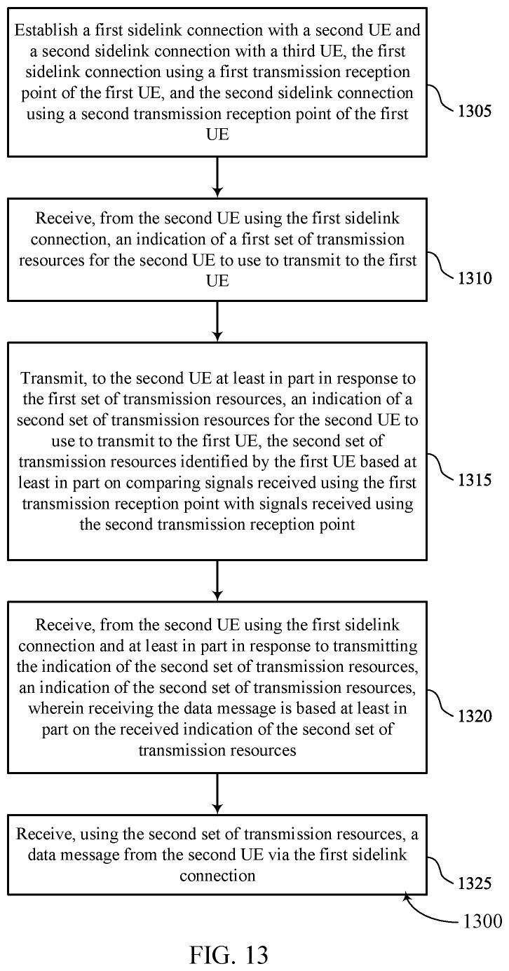

FIG. 13 shows a flowchart illustrating a method 1300 that supports sidelink user equipment scheduling of spatial division multiplexing receiver with multiple transmission-reception points in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include establishing a first sidelink connection with a second UE and a second sidelink connection with a third UE, the first sidelink connection using a first transmission reception point of the first UE, and the second sidelink connection using a second transmission reception point of the first UE. The operations of 1305 may be performed in accordance with examples as disclosed herein. In some examples, aspects of the operations of 1305 may be performed by a sidelink connection component 1025 as described with reference to FIG. 10.

At 1310, the method may include receiving, from the second UE using the first sidelink connection, an indication of a first set of transmission resources for the second UE to use to transmit to the first UE. The operations of 1310 may be performed in accordance with examples as disclosed herein. In some examples, aspects of the operations of 1310 may be performed by a first resources component 1030 as described with reference to FIG. 10.

At 1315, the method may include transmitting, to the second UE at least in part in response to the first set of transmission resources, an indication of a second set of transmission resources for the second UE to use to transmit to the first UE, the second set of transmission resources identified by the first UE based on comparing signals received using the first transmission reception point with signals received using the second transmission reception point. The operations of 1315 may be performed in accordance with examples as disclosed herein. In some examples, aspects of the operations of 1315 may be performed by a second resources component 1035 as described with reference to FIG. 10.

At 1320, the method may include receiving, from the second UE using the first sidelink connection and at least in part in response to transmitting the indication of the second set of transmission resources, an indication of the second set of transmission resources, where receiving the data message is based on the received indication of the second set of transmission resources. The operations of 1320 may be performed in accordance with examples as disclosed herein. In some examples, aspects of the operations of 1320 may be performed by a second resources component 1035 as described with reference to FIG. 10.

At 1325, the method may include receiving, using the second set of transmission resources, a data message from the second UE via the first sidelink connection. The operations of 1325 may be performed in accordance with examples as disclosed herein. In some examples, aspects of the operations of 1325 may be performed by a data message component 1040 as described with reference to FIG. 10.

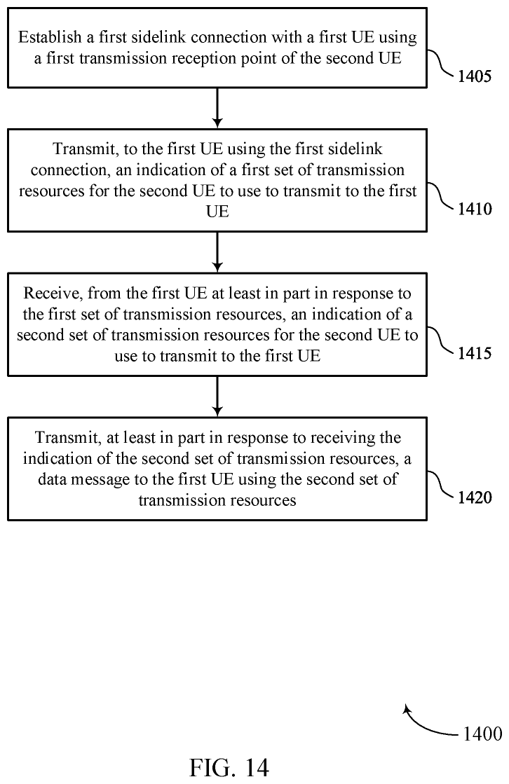

FIG. 14 shows a flowchart illustrating a method 1400 that supports sidelink user equipment scheduling of spatial division multiplexing receiver with multiple transmission-reception points in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1405, the method may include establishing a first sidelink connection with a first UE using a first transmission reception point of the second UE. The operations of 1405 may be performed in accordance with examples as disclosed herein. In some examples, aspects of the operations of 1405 may be performed by a sidelink connection component 1025 as described with reference to FIG. 10.

At 1410, the method may include transmitting, to the first UE using the first sidelink connection, an indication of a first set of transmission resources for the second UE to use to transmit to the first UE. The operations of 1410 may be performed in accordance with examples as disclosed herein. In some examples, aspects of the operations of 1410 may be performed by a first resources component 1030 as described with reference to FIG. 10.

At 1415, the method may include receiving, from the first UE at least in part in response to the first set of transmission resources, an indication of a second set of transmission resources for the second UE to use to transmit to the first UE. The operations of 1415 may be performed in accordance with examples as disclosed herein. In some examples, aspects of the operations of 1415 may be performed by a second resources component 1035 as described with reference to FIG. 10.

At 1420, the method may include transmitting, at least in part in response to receiving the indication of the second set of transmission resources, a data message to the first UE using the second set of transmission resources. The operations of 1420 may be performed in accordance with examples as disclosed herein. In some examples, aspects of the operations of 1420 may be performed by a data message component 1040 as described with reference to FIG. 10.

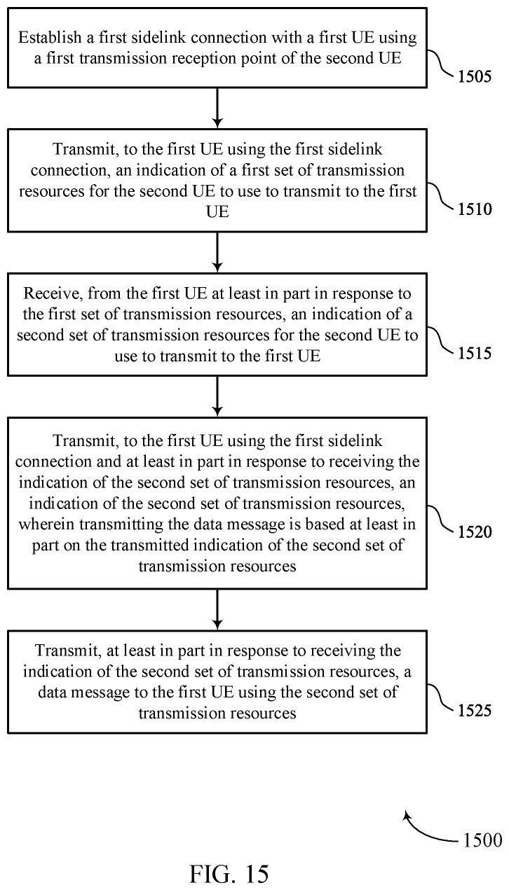

FIG. 15 shows a flowchart illustrating a method 1500 that supports sidelink user equipment scheduling of spatial division multiplexing receiver with multiple transmission-reception points in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1505, the method may include establishing a first sidelink connection with a first UE using a first transmission reception point of the second UE. The operations of 1505 may be performed in accordance with examples as disclosed herein. In some examples, aspects of the operations of 1505 may be performed by a sidelink connection component 1025 as described with reference to FIG. 10.

At 1510, the method may include transmitting, to the first UE using the first sidelink connection, an indication of a first set of transmission resources for the second UE to use to transmit to the first UE. The operations of 1510 may be performed in accordance with examples as disclosed herein. In some examples, aspects of the operations of 1510 may be performed by a first resources component 1030 as described with reference to FIG. 10.

At 1515, the method may include receiving, from the first UE at least in part in response to the first set of transmission resources, an indication of a second set of transmission resources for the second UE to use to transmit to the first UE. The operations of 1515 may be performed in accordance with examples as disclosed herein. In some examples, aspects of the operations of 1515 may be performed by a second resources component 1035 as described with reference to FIG. 10.

At 1520, the method may include transmitting, to the first UE using the first sidelink connection and at least in part in response to receiving the indication of the second set of transmission resources, an indication of the second set of transmission resources, where transmitting the data message is based on the transmitted indication of the second set of transmission resources. The operations of 1520 may be performed in accordance with examples as disclosed herein. In some examples, aspects of the operations of 1520 may be performed by a second resources component 1035 as described with reference to FIG. 10.

At 1525, the method may include transmitting, at least in part in response to receiving the indication of the second set of transmission resources, a data message to the first UE using the second set of transmission resources. The operations of 1525 may be performed in accordance with examples as disclosed herein. In some examples, aspects of the operations of 1525 may be performed by a data message component 1040 as described with reference to FIG. 10.

The following provides an overview of aspects of the present disclosure:

Aspect 1: A method for wireless communications at a first UE, comprising: establishing a first sidelink connection with a second UE and a second sidelink connection with a third UE, the first sidelink connection using a first transmission reception point of the first UE, and the second sidelink connection using a second transmission reception point of the first UE; receiving, from the second UE using the first sidelink connection, an indication of a first set of transmission resources for the second UE to use to transmit to the first UE; transmitting, to the second UE at least in part in response to the first set of transmission resources, an indication of a second set of transmission resources for the second UE to use to transmit to the first UE, the second set of transmission resources identified by the first UE based at least in part on comparing signals received using the first transmission reception point with signals received using the second transmission reception point; and receiving, using the second set of transmission resources, a data message from the second UE via the first sidelink connection.

Aspect 2: The method of aspect 1, further comprising: receiving, from the second UE using the first sidelink connection and at least in part in response to transmitting the indication of the second set of transmission resources, an indication of the second set of transmission resources, wherein receiving the data message is based at least in part on the received indication of the second set of transmission resources.

Aspect 3: The method of any of aspects 1 through 2, wherein the second set of transmission resources at least partially overlaps in time and frequency with a third set of transmission resources for the third UE to use to transmit to the first UE, the third set of transmission resources based at least in part on the second transmission reception point.

Aspect 4: The method of aspect 3, wherein the second set of transmission resources are spatially division multiplexed with the third set of transmission resources.

Aspect 5: The method of any of aspects 1 through 4, wherein comparing signals received using the first transmission reception point with signals received using the second transmission reception point comprises: performing a first measurement associated with the first transmission reception point; performing a second measurement associated with the second transmission reception point; and comparing the first measurement and the second measurement to determine the second set of transmission resources.

Aspect 6: The method of aspect 5, wherein the first measurement and the second measurement comprise reference signal received power measurements.

Aspect 7: The method of any of aspects 5 through 6, wherein determining the second set of transmission resources is based at least in part on a difference between the first measurement and the second measurement satisfying a threshold.

Aspect 8: The method of any of aspects 1 through 7, wherein the indication of the second set of transmission resources comprises an indication of a subchannel index, a transmission time, a demodulation reference signal port index, or any combination thereof.

Aspect 9: The method of any of aspects 1 through 8, wherein the indication of the second set of transmission resources allocates a first demodulation reference signal cyclic shift to the second UE and a second demodulation reference signal cyclic shift to the third UE based at least in part on the second UE and the third UE communicating via the second set of transmission resources.

Aspect 10: The method of any of aspects 1 through 9, wherein the indication of the second set of transmission resources allocates first interference management resources to the second UE and second interference management resources to the third UE.

Aspect 11: The method of any of aspects 1 through 10, wherein transmitting the indication of the second set of transmission resources comprises: transmitting sidelink control information to the second UE using the first sidelink connection.

Aspect 12: The method of any of aspects 1 through 11, wherein transmitting the indication of the second set of transmission resources comprises: broadcasting the indication of the second set of transmission resources to the second UE and the third UE.

Aspect 13: The method of any of aspects 1 through 12, wherein a first group of UEs comprises the second UE and a second group of UEs comprises the third UE.

Aspect 14: The method of aspect 13, further comprising: transmitting the indication of the second set of transmission resources for the second UE to the first group of UEs, the indication comprising a group index.

Aspect 15: The method of any of aspects 13 through 14, further comprising: scheduling a fourth UE of the first group of UEs with different resources than the second set of transmission resources.

Aspect 16: A method for wireless communication at a second UE, comprising: establishing a first sidelink connection with a first UE using a first transmission reception point of the second UE; transmitting, to the first UE using the first sidelink connection, an indication of a first set of transmission resources for the second UE to use to transmit to the first UE; receiving, from the first UE at least in part in response to the first set of transmission resources, an indication of a second set of transmission resources for the second UE to use to transmit to the first UE; and transmitting, at least in part in response to receiving the indication of the second set of transmission resources, a data message to the first UE using the second set of transmission resources.

Aspect 17: The method of aspect 16, further comprising: transmitting, to the first UE using the first sidelink connection and at least in part in response to receiving the indication of the second set of transmission resources, an indication of the second set of transmission resources, wherein transmitting the data message is based at least in part on the transmitted indication of the second set of transmission resources.

Aspect 18: The method of any of aspects 16 through 17, wherein the received indication of the second set of transmission resources comprises an indication of a subchannel index, a transmission time, a demodulation reference signal port index, or any combination thereof.

Aspect 19: The method of any of aspects 16 through 18, wherein the received indication of the second set of transmission resources allocates a first demodulation reference signal cyclic shift to the second UE and a second demodulation reference signal cyclic shift to a third UE based at least in part on the second UE and the third UE communicating via the second set of transmission resources.

Aspect 20: The method of any of aspects 16 through 19, wherein the received indication of the second set of transmission resources allocates first interference management resources to the second UE and second interference management resources to a third UE.

Aspect 21: The method of any of aspects 16 through 20, wherein receiving the indication of the second set of transmission resources comprises: receiving sidelink control information from the first UE using the first sidelink connection.

Aspect 22: The method of any of aspects 16 through 21, wherein receiving the indication of the second set of transmission resources comprises: receiving a broadcast signal from the first UE comprising the indication of the second set of transmission resources.

Aspect 23: The method of any of aspects 16 through 22, wherein a first group of UEs comprises the second UE and a second group of UEs comprises the third UE.

Aspect 24: The method of aspect 23, wherein the indication of the second set of transmission resources is associated with the first group of UEs, the indication comprising a group index.

Aspect 25: An apparatus for wireless communications at a first UE, comprising a processor; memory coupled with the processor; and instructions stored in the memory and executable by the processor to cause the apparatus to perform a method of any of aspects 1 through 15.

Aspect 26: An apparatus for wireless communications at a first UE, comprising at least one means for performing a method of any of aspects 1 through 15.

Aspect 27: A non-transitory computer-readable medium storing code for wireless communications at a first UE, the code comprising instructions executable by a processor to perform a method of any of aspects 1 through 15.

Aspect 28: An apparatus for wireless communication at a second UE, comprising a processor; memory coupled with the processor; and instructions stored in the memory and executable by the processor to cause the apparatus to perform a method of any of aspects 16 through 24.

Aspect 29: An apparatus for wireless communication at a second UE, comprising at least one means for performing a method of any of aspects 16 through 24.

Aspect 30: A non-transitory computer-readable medium storing code for wireless communication at a second UE, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
establishing a first sidelink connection with a second UE and a second sidelink connection with a third UE, the first sidelink connection using a first transmission reception point of the first UE, and the second sidelink connection using a second transmission reception point of the first UE;
receiving, from the second UE using the first sidelink connection, an indication of a first set of transmission resources for the second UE to use to transmit to the first UE;
transmitting, to the second UE at least in part in response to the first set of transmission resources, an indication of a second set of transmission resources for the second UE to use to transmit to the first UE, the second set of transmission resources identified by the first UE based at least in part on comparing signals received using the first transmission reception point with signals received using the second transmission reception point; and
receiving, using the second set of transmission resources, a data message from the second UE via the first sidelink connection.

2. The method of claim 1, further comprising:
receiving, from the second UE using the first sidelink connection and at least in part in response to transmitting the indication of the second set of transmission resources, an indication of the second set of transmission resources, wherein receiving the data message is based at least in part on the received indication of the second set of transmission resources.

3. The method of claim 1, wherein the second set of transmission resources at least partially overlaps in time and frequency with a third set of transmission resources for the third UE to use to transmit to the first UE, the third set of transmission resources based at least in part on the second transmission reception point.

4. The method of claim 3, wherein the second set of transmission resources are spatially division multiplexed with the third set of transmission resources.

5. The method of claim 1, wherein comparing signals received using the first transmission reception point with signals received using the second transmission reception point comprises:
performing a first measurement associated with the first transmission reception point;
performing a second measurement associated with the second transmission reception point; and
comparing the first measurement and the second measurement to determine the second set of transmission resources.

6. The method of claim 5, wherein the first measurement and the second measurement comprise reference signal received power measurements.

7. The method of claim 5, wherein determining the second set of transmission resources is based at least in part on a difference between the first measurement and the second measurement satisfying a threshold.

8. The method of claim 1, wherein the indication of the second set of transmission resources comprises an indication of a subchannel index, a transmission time, a demodulation reference signal port index, or any combination thereof.

9. The method of claim 1, wherein the indication of the second set of transmission resources allocates a first demodulation reference signal cyclic shift to the second UE and a second demodulation reference signal cyclic shift to the third UE based at least in part on the second UE and the third UE communicating via the second set of transmission resources.

10. The method of claim 1, wherein the indication of the second set of transmission resources allocates first interference management resources to the second UE and second interference management resources to the third UE.

11. The method of claim 1, wherein transmitting the indication of the second set of transmission resources comprises:
transmitting sidelink control information to the second UE using the first sidelink connection.

12. The method of claim 1, wherein transmitting the indication of the second set of transmission resources comprises:
broadcasting the indication of the second set of transmission resources to the second UE and the third UE.

13. The method of claim 1, wherein a first group of UEs comprises the second UE and a second group of UEs comprises the third UE.

14. The method of claim 13, further comprising:
transmitting the indication of the second set of transmission resources for the second UE to the first group of UEs, the indication comprising a group index.

15. The method of claim 13, further comprising:
scheduling a fourth UE of the first group of UEs with different resources than the second set of transmission resources.

16. A method for wireless communication at a second user equipment (UE), comprising:
establishing a first sidelink connection with a first UE using a first transmission reception point of the second UE;
transmitting, to the first UE using the first sidelink connection, an indication of a first set of transmission resources for the second UE to use to transmit to the first UE;
receiving, from the first UE at least in part in response to the first set of transmission resources, an indication of a second set of transmission resources for the second UE to use to transmit to the first UE; and
transmitting, at least in part in response to receiving the indication of the second set of transmission resources, a data message to the first UE using the second set of transmission resources.

17. The method of claim 16, further comprising:
transmitting, to the first UE using the first sidelink connection and at least in part in response to receiving the indication of the second set of transmission resources, an indication of the second set of transmission resources, wherein transmitting the data message is based at least in part on the transmitted indication of the second set of transmission resources.

18. The method of claim 16, wherein the received indication of the second set of transmission resources comprises an indication of a subchannel index, a transmission time, a demodulation reference signal port index, or any combination thereof.

19. The method of claim 16, wherein the received indication of the second set of transmission resources allocates a first demodulation reference signal cyclic shift to the second UE and a second demodulation reference signal cyclic shift to a third UE based at least in part on the second UE and the third UE communicating via the second set of transmission resources.

20. The method of claim 16, wherein the received indication of the second set of transmission resources allocates first interference management resources to the second UE and second interference management resources to a third UE.

21. The method of claim 16, wherein receiving the indication of the second set of transmission resources comprises:
receiving sidelink control information from the first UE using the first sidelink connection.

22. The method of claim 16, wherein receiving the indication of the second set of transmission resources comprises:
receiving a broadcast signal from the first UE comprising the indication of the second set of transmission resources.

23. The method of claim 16, wherein a first group of UEs comprises the second UE and a second group of UEs comprises the third UE.

24. The method of claim 23, wherein the indication of the second set of transmission resources is associated with the first group of UEs, the indication comprising a group index.

25. An apparatus for wireless communications at a first user equipment (UE), comprising:
a processor;
memory coupled with the processor; and
instructions stored in the memory and executable by the processor to cause the apparatus to:
establish a first sidelink connection with a second UE and a second sidelink connection with a third UE, the first sidelink connection using a first transmission reception point of the first UE, and the second sidelink connection using a second transmission reception point of the first UE;
receive, from the second UE using the first sidelink connection, an indication of a first set of transmission resources for the second UE to use to transmit to the first UE;
transmit, to the second UE at least in part in response to the first set of transmission resources, an indication of a second set of transmission resources for the second UE to use to transmit to the first UE, the second set of transmission resources identified by the first UE based at least in part on comparing signals received using the first transmission reception point with signals received using the second transmission reception point; and
receive, using the second set of transmission resources, a data message from the second UE via the first sidelink connection.

26. The apparatus of claim 25, wherein the instructions are further executable by the processor to cause the apparatus to:
receive, from the second UE using the first sidelink connection and at least in part in response to transmitting the indication of the second set of transmission resources, an indication of the second set of transmission resources, wherein receiving the data message is based at least in part on the received indication of the second set of transmission resources.

27. The apparatus of claim 25, wherein the second set of transmission resources at least partially overlaps in time and frequency with a third set of transmission resources for the third UE to use to transmit to the first UE, the third set of transmission resources based at least in part on the second transmission reception point.

28. An apparatus for wireless communication at a second user equipment (UE), comprising:
a processor;
memory coupled with the processor; and
instructions stored in the memory and executable by the processor to cause the apparatus to:
establish a first sidelink connection with a first UE using a first transmission reception point of the second UE;
transmit, to the first UE using the first sidelink connection, an indication of a first set of transmission resources for the second UE to use to transmit to the first UE;
receive, from the first UE at least in part in response to the first set of transmission resources, an indication of a second set of transmission resources for the second UE to use to transmit to the first UE; and
transmit, at least in part in response to receiving the indication of the second set of transmission resources, a data message to the first UE using the second set of transmission resources.

29. The apparatus of claim 28, wherein the instructions are further executable by the processor to cause the apparatus to:
transmit, to the first UE using the first sidelink connection and at least in part in response to receiving the indication of the second set of transmission resources, an indication of the second set of transmission resources, wherein transmitting the data message is based at least in part on the transmitted indication of the second set of transmission resources.

30. The apparatus of claim 28, wherein the received indication of the second set of transmission resources comprises an indication of a subchannel index, a transmission time, a demodulation reference signal port index, or any combination thereof.
